(19) United States
(12) Patent Application Publication
(10) Pub. No.: US 2007/0195016 A1
(43) Pub. Date: Aug. 23, 2007

(54) PLASMA DISPLAY DEVICE AND METHOD OF DRIVING THE SAME

(76) Inventor: Taku Okada, Kadoma-shi (JP)

Correspondence Address: SNELL & WILMER LLP (OC), 600 ANTON BOULEVARD, SUITE 1400, COSTA MESA, CA, 92626, US

(21) Appl. No.: 11/737,015

(22) Filed: Apr. 18, 2007

Related U.S. Application Data
(62) Division of application No. 10/481,687, filed on Jul. 19, 2004.

(30) Foreign Application Priority Data
Jun. 20, 2001 (JP) 2001-186141

(51) Int. Cl. G09G 3/28

(52) U.S. Cl. 345/68

(57) ABSTRACT

The present invention is such that a method of driving a plasma display device, the plasma display device including (i) a PDP unit that includes a first and a second substrate arranged so as to face each other, the first substrate having pairs of a first and a second display electrode disposed on a surface that faces the second substrate and a dielectric layer covering the pairs of the first and second display electrodes, and (ii) a PDP driving unit that drives the PDP unit based on an intra-field time division grayscale display method, and includes a plurality of LC resonant circuits for recovering reactive power from power supplied to the display electrodes while driving, the method comprising: a recovering step of recovering the reactive power using the LC resonant circuits during a falling period of a sustain pulse; and a supplying step of supplying the recovered reactive power to the display electrodes during a rising period of the sustain pulse, wherein the PDP driving unit repeats the recovering step and the supplying step cyclically, and in each cycle, the falling period of the sustain pulse applied to the first display electrodes and the rising period of the sustain pulse applied to the second display electrodes overlap at least partially.

### CROSS-REFERENCE TO RELATED APPLICATIONS

The present application is a divisional application of U.S. patent application Ser. No. 10/481,687 filed on Jul. 19, 2004.

### TECHNICAL FIELD

The present invention relates to a plasma display device and a method of driving the same.

### BACKGROUND ART

A plasma display device includes a plasma display panel (PDP) unit that has a front panel glass and a back panel glass facing each other with a plurality of barrier ribs in a space between the two panel glasses. Phosphor layers each being one of red, green, and blue are each disposed between two adjacent barrier ribs, and a discharge gas is enclosed in discharge spaces between the panel glasses. Pairs of display electrodes (each pair includes a scanning electrode and a sustaining electrode) are disposed in stripes on the front panel glass. A plurality of address electrodes (data electrodes) are disposed in stripes on the back panel glass, so as to be positioned at right angles to the display electrodes with the discharge spaces between the display electrodes and the address electrodes. A dielectric layer is disposed on a surface of each panel glasses, so as to cover the electrodes. The PDP unit is connected to a PDP driving unit that drives the PDP, and thus the plasma display device is formed.

In the PDP unit, an incorporated pre-processor applies pulses in response to image data inputted from an external image device, to the display electrodes and the address electrodes based on a driving waveform process in each period of an initialization period, a write period, a sustain period, and an erase period. The PDP unit is fluoresced by a discharge generated in the discharge gas.

Such a plasma display device is advantageous in that even when a panel size is made larger and a definition is made higher, weight and depth do not increase too much in comparison with a conventional cathode ray tube. Also, a viewing angle of the plasma display pane is not too limited. Demand for a larger and higher-definition plasma display device has become increasingly higher, and plasma display panels of 50 inches or larger have been produced on a commercial basis. Accordingly, development of a plasma display device that has a lower power consumption is desired.

In an average AC Plasma display device, the dielectric layer that is disposed on the surface of the front panel glass forms a condenser having a relatively large capacity at an area corresponding to each pair of display electrodes (the capacity of the condenser is herein after referred to as “panel capacity”). When a driving voltage is applied to any pair of display electrodes, power loss due to reactive power is caused. The reactive power just flows back and forth between the condenser and a power source and is not consumed for anything (the reactive power only charge and discharge the dielectric layer).

A reactive power P₁ that is needed only for the power source to charge and discharge each condenser and does not contribute to the discharge for displaying images can be expressed as in an equation (1), when a panel capacity is Cₚ, and a voltage of applied pulse is Vₛ,
P₁=CₚVₛ² (1)

When a sustain pulse is applied to each of the pairs of display electrodes repeatedly in the sustain period, the reactive power becomes too large to ignore. Moreover, the panel capacity increases in proportion to the size of the PDP unit, and as the PDP unit becomes larger, the power consumption due to the reactive power considerably increases.

In order to reduce the power consumption of the AC plasma display device, Japanese Laid-Open Patent Application No. H7-109542 discloses, as one solution to improve display efficiency, sustain pulse generating circuits 112a and 112b as reactive power recovery circuits, utilizing LC resonant circuits that are tank circuits as shown in FIG. 8. In the circuits 112a and 112b, an area of the panel above and between each pair of display electrodes (a scanning electrodes 19a_{N} and a sustaining electrodes 19b_{N}) that is indicated is simply as the panel in the drawing is equivalent to a condenser, and a reactive circuit is formed by serially connecting the scanning electrodes 19a_{N} to a coil 310 and a condenser 308, and the sustain electrodes 19b_{N} to a coil 311 and a condenser 309, respectively. The circuits 112a and 112b are provided with switching elements 300-307, and control signals 50-57 are transmitted to the switching elements 300-307, respectively, from the preprocessor that is a main controlling unit of the PDP driving unit. During a period in which any of the control signals 50-57 are outputted at a high-level, corresponding switching elements are turned on, and power from an external power source Vsus or the condensers 308 and 309 are supplied to the scanning electrodes 19a_{N} and the sustaining electrodes 19b_{N}. Diodes 312-315 rectify a current flowing through the circuits 112a and 112b.

Driving waveforms of such sustain pulse generating circuits 112b and 112b, as shown in FIG. 24A, are such that pulses of the circuits 112b and 112b each have a rising period and a falling period, and the pulses of the circuits 112b and 112b are applied alternately. With the circuits 112a and 112b, the reactive power is recovered during the falling period, and the recovered reactive power is supplied to the scanning electrodes 19a_{N} and the sustaining electrodes 19b_{N} in the rising period. As shown in FIG. 24A, in a conventional driving waveform process during a sustain period, a sustain pulse to one of the scanning electrodes 19a_{N} and the sustaining electrodes 19b_{N} is applied only after a prior sustain pulse to another of the scanning electrodes 19a_{N} and the sustaining electrodes 19b_{N} ends.

An example of operation of the circuits based on the sustain pulses illustrated in FIG. 24A is explained below.

First of all, during the rising period of the sustain pulse to the display electrodes 19a_{N}, only the switching elements 303 and 304 are turned on, and the reactive power that has already been recovered in the condenser 308 is supplied to the display electrodes 19a_{N}. At this time, the switching element 307 is also turned on. Next, the switching elements 300 and 303 are turned on, and a sustain voltage Vs is applied to the display electrodes 19a_{N}, and the display electrodes 19b_{N} are grounded. Then, the switching elements 303, 305, and 307 are turned on, and charges are accumulated in the condenser 309 from the display electrodes 19a_{N} and the reactive power is recovered. The above explained operation is also performed to the display electrodes 19b_{N} in the same way.

As has been described, the sustain pulse generating circuits 112b and 112b apply the reactive power recovered during the falling period of a preceding sustain pulse to the scanning electrodes 19a_{N} and the sustaining electrodes 19b_{N} in the rising period of a succeeding sustain pulse, and thus it is possible to facilitate the reactive power so as to reduce power loss and improve the display efficiency.

The power loss due to the reactive power in the sustain pulse generating circuits 112b and 112b can be expressed as follows. When a rising period of a sustain pulse Pₛ is tᵣ, a serial resistance that corresponds to a total amount of resistance of the sustain pulse generating circuit 112a (or 112b) and the panel is R, and an inductance of the coil 310 is L, a reactive power loss per sustain pulse P₂ is expressed by an equation 2.
P₂=(tᵣR/4L)CₚVₛ² (2)

Here, tᵣ and L has a correlation, and it is not possible to change only one of them. The equation indicates that the power loss is reduced by (tᵣR/4L) when the sustain pulse generating circuits 112a and 112b recover the reactive power, in comparison with a case in which the reactive power recovery is not performed at all.

Note that the equation 2 also works when the rising period tᵣ is replaced by a falling period t_{f}.

Further, a relation among a tilt period tₛ (the rising period tᵣ or the falling period t_{f}), the inductance of the coil 310 is L, and the panel capacity is Cₚ is expressed by the following equation.
tₛ=π□(LCₚ) (3)

An equation 4 indicates a case in which the equation 3 is substituted in the equation 2.
P₂=(π²R/4tₛ)Cₚ²Vₛ² (4)

As shown by the equations, in a case in which the sustain pulse generating circuits 112a and 112b is employed, the reactive power loss becomes larger as the rising period tᵣ or the falling period t_{f} becomes smaller.

In recent years, a demand for high-definition and large display PDPs has become increasingly higher. In order to achieve a high-definition PDP unit, it is also necessary to realize an increased number of scanning lines, as well as a high-speed driving by narrowing pitches of sustaining pulses applied to the display electrodes, and such.

However, when a width of a pulse peak is too small, the rising period tᵣ and the falling period t_{f} also become smaller. Such a tendency is not desirable in terms with reduction of power consumption, because it could increase an amount of the power loss due to the reactive power in the plasma display device.

### DISCLOSURE OF THE INVENTION

The present invention is made in view of the above circumstance. An object of the present invention is to provide a plasma display device that can drive at a relatively low power consumption without increasing power loss due to reactive power even when a case of the plasma display device having a high-definition PDP unit (such as a hi-vision display) and when driven at a high-speed with shortened pitches of sustain pulses applied to display electrodes during a sustain period, and a method of driving the plasma display device.

In order to solve the above problem, the present invention is a method of driving a plasma display device, the plasma display device including (i) a PDP unit that includes a first and a second substrate arranged so as to face each other, the first substrate having pairs of a first and a second display electrode disposed on a surface that faces the second substrate and a dielectric layer covering the pairs of the first and second display electrodes, and (ii), a PDP driving unit that drives the PDP unit based on an intra-field time division grayscale display method, and includes a plurality of LC resonant circuits for recovering reactive power from power supplied to the display electrodes while driving, the method comprising: a recovering step of recovering the reactive power using the LC resonant circuits during a falling period of a sustain pulse; and a supplying step of supplying the recovered reactive power to the display electrodes during a rising period of the sustain pulse, wherein the PDP driving unit repeats the recovering step and the supplying step cyclically, and in each cycle, the falling period of the sustain pulse applied to the first display electrodes and the rising period of the sustain pulse applied to the second display electrodes overlap at least partially.

According to the above driving method, it is possible to make an interval between the sustain pulses applied to each pair of display electrodes shorter, without making tilts in waveforms sharp during the rising period and the falling period, by having the rising period for one of the first and second electrodes and the falling period for the other overlap. With the present invention, it is not necessary to make a sustain pulse width as narrow as the conventional plasma display device, even when a case of the plasma display device having a high-definition PDP unit (such as a hi-vision display) and when driven at a high-speed using an intra-field time division grayscale display method with shortened subfields. Therefore, it is possible to reduce the power loss due to the reactive power effectively and achieve an excellent display performance.

With the present invention, it is possible to achieve the highest effect when t_{f} and tᵣ overlap completely, where t_{f} is the falling period of the sustain pulse applied to the first display electrodes, and tᵣ is the rising period of the sustain pulse applied to the second display electrodes.

Further, the present invention also has an effect for reducing the power loss due the reactive power even when the rising periods tᵣ and the falling period t_{f} are made slightly shorter, and accordingly it is possible to reduce the power consumption with a high-speed drive.

Further, it is possible to make the present invention such that a plasma display device comprising: a PDP unit that includes a first and a second substrate arranged so as to face each other, the first substrate having pairs of a first and a second display electrode disposed on a surface that faces the second substrate and a dielectric layer covering the pairs of the first and second display electrodes; and a PDP driving unit that drives the PDP unit based on an intra-field time division grayscale display method, and includes a plurality of LC resonant circuits for recovering reactive power from power supplied to the display electrodes while driving, wherein the PDP driving unit repeats a cycle of recovering the reactive power using the LC resonant circuits during a falling period of a sustain pulse, and supplying the recovered reactive power to the display electrodes during a rising period of the sustain pulse, and in each cycle, the falling period of the sustain pulse applied to the first display electrodes and the rising period of the sustain pulse applied to the second display electrodes overlap at least partially.

In this case, it is also possible that t_{f} and tᵣ overlap completely, where t_{f} is the falling period of the sustain pulse applied to the first display electrodes, and tᵣ is the rising period of the sustain pulse applied to the second display electrodes.

Further, the PDP unit may also include the LC resonant circuits that are each connected to a different display electrode.

Further, the present invention maybe such that a plasma display driving device that drives a PDP unit based on an intra-field time division grayscale display method to display an image, and recovers reactive power from power supplied to the PDP unit to improves display efficiency, the PDP unit including a first and a second substrate arranged so as to face each other, the first substrate having pairs of a first and a second display electrode disposed on a surface that faces the second substrate, the plasma display driving device comprising: a first reactive power recovery circuit that recovers reactive power from power supplied to the first display electrodes; and a second reactive power recovery circuit that recovers reactive power from power supplied to the second display electrodes, wherein the first and second reactive power recovery circuits are electrically connected in series via the pairs of display electrodes during a period in each subfield, the reactive power recovered by one of the reactive power recovery circuits is transferred to the other reactive power recovery circuit via the pairs of display electrodes.

In this case, it is preferable that the period in each subfield is a period in which a rising period of the sustain pulse applied to the first display electrodes and a falling period of the sustain pulse applied to the second display electrodes overlap.

Further, the present invention may have such a structure that the first and second reactive power recovery circuits are each provided with a voltage application circuit and a ground circuit that are in parallel, when a sustain discharge is performed, the first and second reactive power recovery circuits are disconnected from the display electrodes, the voltage application circuit provided for one of the first and second reactive power recovery circuits is connected to one of the display electrode in each pair, and the ground circuit provided for the other reactive power recovery circuit is connected to the other display electrodes in the pair.

In this case, the reactive power recovery circuits may be reactive circuits.

Specifically, it is desirable that the reactive circuits are LC resonant circuits.

Moreover, the present invention may also be such that a plasma display driving device further comprising: a first switching unit operable to connect and disconnect the first electrode to and from the first reactive power recovery circuit; a second switching unit operable to connect and disconnect the second electrode to and from the second reactive power recovery circuit; and a controlling unit operable to turn on the first and second switching units at the same time during the period in each subfield.

Further, the present invention also provides a plasma display device comprising: a PDP unit that includes a first and a second substrate arranged so as to face each other, the first substrate having pairs of a first and a second display electrode disposed on a surface that faces the second substrate and a dielectric layer covering the pairs of the first and second display electrodes; and a PDP driving unit that drives the PDP unit based on an intra-field time division grayscale display method, and includes a first reactive power recovery circuit that recovers reactive power from power supplied to the first display electrodes, and a second reactive power recovery circuit that recovers the reactive power from power supplied to the second display electrodes, wherein the first and second reactive power recovery circuits are electrically connected in series via the pairs of display electrodes during a period in each subfield, the reactive power recovered by one of the reactive power recovery circuits is transferred to the other reactive power recovery circuit via the pairs of display electrodes.

The structure of such a plasma display device enables the driving method of the present invention as has been described above.

The reactive power recovery circuits may be reactive circuits. Specifically, it is preferable that the reactive circuits are LC resonant circuits.

The present invention may also include a first switching unit operable to connect and disconnect the first electrode to and from the first reactive power recovery circuit; a second switching unit operable to connect and disconnect the second electrode to and from the second reactive power recovery circuit; and a controlling unit operable to turn on the first and second switching units at the same time during the period in each subfield.

In this case, the period in each subfield is a period in which a rising period of the sustain pulse applied to the first display electrodes and a falling period of the sustain pulse applied to the second display electrodes overlap.

Further, the present invention may have such a structure that the first and second reactive power recovery circuits are each provided with a voltage application circuit and a ground circuit that are in parallel, when a sustain discharge is performed, the first and second reactive power recovery circuits are disconnected from the display electrodes, the voltage application circuit provided for one of the first and second reactive power recovery circuits is connected to one of the display electrode in each pair, and the ground circuit provided for the other reactive power recovery circuit is connected to the other display electrodes in the pair.

### BRIEF DESCRIPTION OF THE DRAWINGS

FIG. 1 is a partial perspective view illustrating a structure of a PDP unit.

FIG. 2 is a diagram illustrating a matrix of display electrodes and data electrodes of the PDP unit.

FIG. 3 is a diagram illustrating a frame division method when driving a plasma display device.

FIG. 4 is a timing chart when pulses are applied to display electrodes and data electrodes in one subfield.

FIG. 5 is a block diagram illustrating a structure of the plasma display device.

FIG. 6 is a block diagram illustrating a structure of a scanning driver.

FIG. 7 is a block diagram illustrating a structure of a data driver.

FIG. 8 is a diagram illustrating a structure of sustain pulse generating circuits of the scanning driver and the sustain driver.

FIG. 9 illustrates detailed waveforms of sustain pulses during a sustain period of a first embodiment, and a timing chart for on/off of control signals to switching elements of the sustain pulse generating circuits.

FIGS. 10A and 10B illustrate detailed waveforms of the sustain pulses and a current flow in the sustain pulse generating circuits during a sub-period A.

FIGS. 11A and 11B illustrate detailed waveforms of the sustain pulses and a current flow in the sustain pulse generating circuits during a sub-period B.
FIGS. 12A and 12B illustrate detailed waveforms of the sustain pulses and a current flow in the sustain pulse generating circuits during a sub-period C.
FIGS. 13A and 13B illustrate detailed waveforms of the sustain pulses and a current flow in the sustain pulse generating circuits during a sub-period D.

FIG. 14 illustrates detailed waveforms of sustain pulses during the sustain period of a second embodiment, and a timing chart for on/off of control signals to switching elements in the sustain pulse generating circuits.

FIGS. 15A and 15B illustrate detailed waveforms of the sustain pulses and a current flow in the sustain pulse generating circuits during a sub-period A-a1.

FIGS. 16A and 16B illustrate detailed waveforms of the sustain pulses and a current flow in the sustain pulse generating circuits during a sub-period A-a2.

FIGS. 17A and 17B illustrate detailed waveforms of the sustain pulses and a current flow in the sustain pulse generating circuits during a sub-period A-a3.

FIGS. 18A and 18B illustrate detailed waveforms of the sustain pulses and a current flow in the sustain pulse generating circuits during a sub-period B.

FIGS. 19A and 19B illustrates detailed waveforms of the sustain pulses and a current flow in the sustain pulse generating circuits during a sub-period C-c1.

FIGS. 20A and 20B illustrate detailed waveforms of the sustain pulses and a current flow in the sustain pulse generating circuits during a sub-period C-c2.

FIGS. 21A and 21B illustrate detailed waveforms of the sustain pulses and a current flow in the sustain pulse generating circuits during a sub-period C-c3.

FIGS. 22A and 22B illustrate detailed waveforms of the sustain pulses and a current flow in the sustain pulse generating circuits during a sub-period D.

FIGS. 23A and 23B show diagrams illustrating a relation between an amount of reactive power and time to recover the reactive power in both a conventional plasma display device and the plasma display device of the present invention.

FIGS. 24A and 24B illustrate waveforms of the sustain pulses of the conventional plasma display panel provided with sustain pulse generating circuits that are reactive power recovery circuits (LC resonant circuits).

### BEST MODE FOR CARRYING OUT THE INVENTION

Although the present invention is explained in reference to preferred embodiments and drawings, those embodiments and drawings are not for showing examples. The present invention is not limited to those examples.

### 1. Structure of Plasma Display Device Common to All Embodiments

1-1 Structure of Plasma Display Panel Common to Embodiments

First, an overall structure of a plasma display device according to the preferred embodiments is explained below.

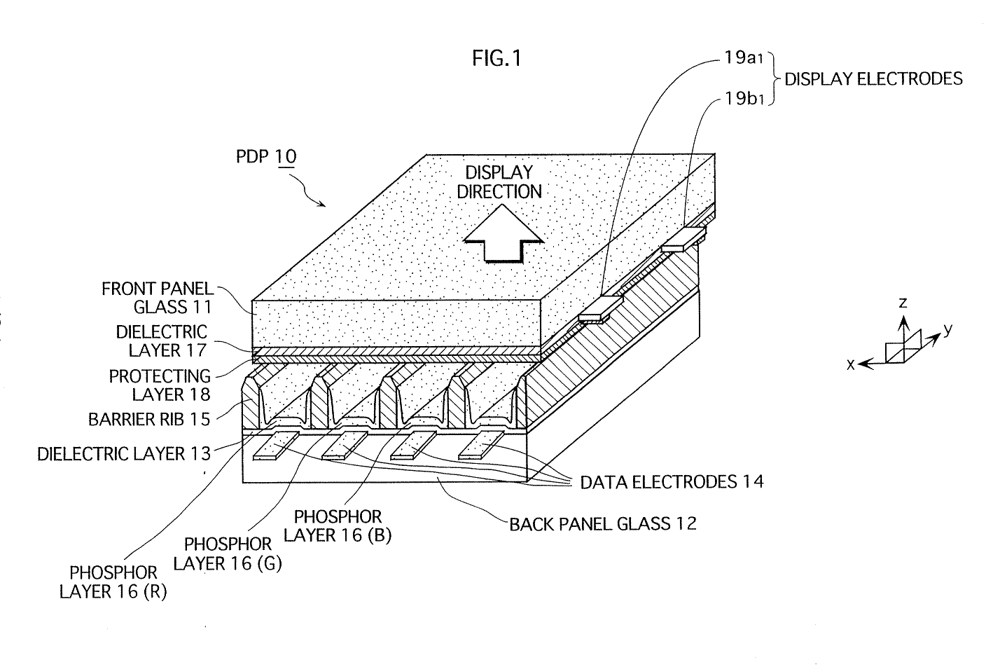

The plasma display device comprises an AC surface discharge PDP unit 10 (FIG. 1) and a PDP driving unit 100 (FIG. 5) that drives the PDP unit 10.

The PDP unit 10 is such that a front panel glass 11 and a back panel glass 12 are positioned in parallel with a space between two panel glasses, and the two panel glasses are sealed together at edges.

On an inner surface of the front panel glass 11, scanning electrodes 19a₁-19a_{N} and sustaining electrodes 19b₁-19b_{N} are disposed alternately in parallel stripes so as to each of the scanning electrodes and the sustaining electrodes form a pair of display electrodes. The display electrodes 19a₁-19a_{N} and 19b₁-19b_{N} are covered by a dielectric layer 17, and a surface of the dielectric layer 17 is covered by a protecting layer 18 (made of MgO, for example). On an inner surface of the back panel glass 12, data electrodes 14₁-14_{M} are disposed in stripes and a dielectric layer 13 (made of MgO, for example) is disposed so as to cover the data electrodes 14₁-14_{M} and the back panel glass 12. On the dielectric layer 13, barrier ribs 15 are disposed in parallel with the data electrodes 14₁-14_{M}. A discharge gas is enclosed in the space between the front panel glass 11 and the back panel glass 12, and the space is partitioned by the barrier ribs 15. Although a pressure at which the discharge gas is enclosed is normally set around 100-500 Torr (around 1×10⁴-7×10⁴ Pa) so that an inner pressure become smaller than the atmospheric pressure, it is advantageous to set the inner pressure higher than 8×10⁴ Pa in order to obtain a higher luminous efficiency.

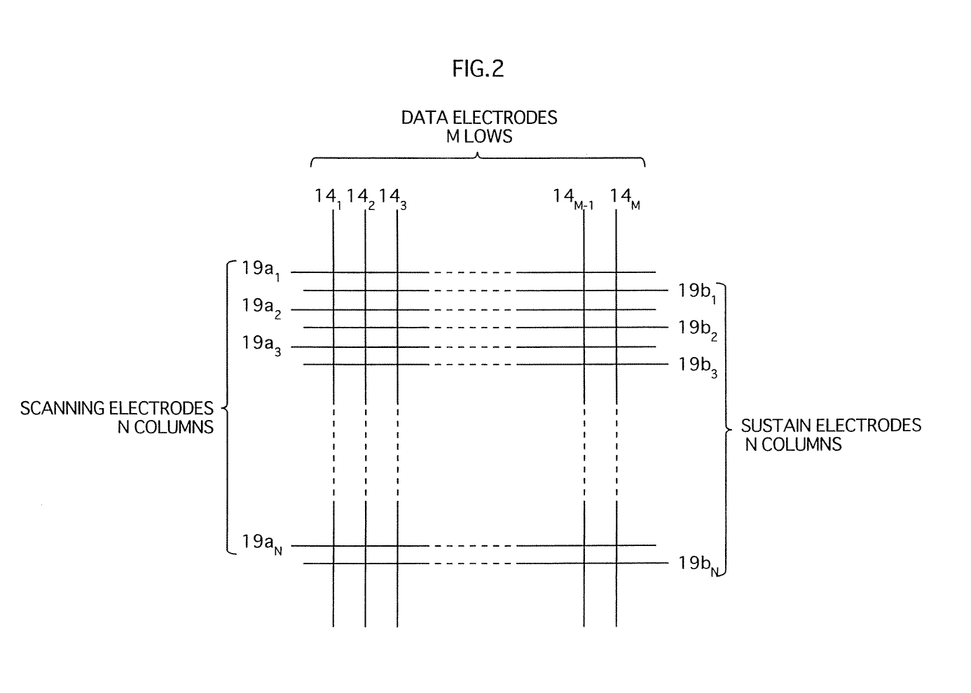

FIG. 2 is a diagram illustrating a matrix of display electrodes and data electrodes of the PDP unit. The display electrodes 19a₁-19a_{N} and 19b₁-19b_{N} and the data electrodes 14₁-14_{M} are disposed so as to positioned orthogonal, and discharge cells are formed at parts where each display electrode and each data electrode cross in the space between the front panel glass 11 and the back panel glass 12. Adjacent discharge cells are partitioned by the barrier ribs 15 so as to prevent dispersion of the discharge to the cells that are next to each other, and this enables a high definition display.

In a case in which the PDP unit 10 is for a monochrome display, a mixed gas mainly comprising Neon is used as the discharge gas, and an image is displayed by emitting visible light when discharging. In a case in which the PDP unit 10 is for a color display as shown in FIG. 1, phosphor layers 16 each made of red (R), green (G), and blue (B) phosphors are formed on inner walls of cells. An example of the discharge gas for this kind of PDP unit is a mixed gas mainly comprising Xenon (Neon-Xenon, or Helium-Xenon), and a color image is displayed by converting ultraviolet rays emitted in the discharge into visible lights of red, green, and blue with the phosphor layer 16.

The PDP unit 10 is driven using an intra-field time division grayscale display method.

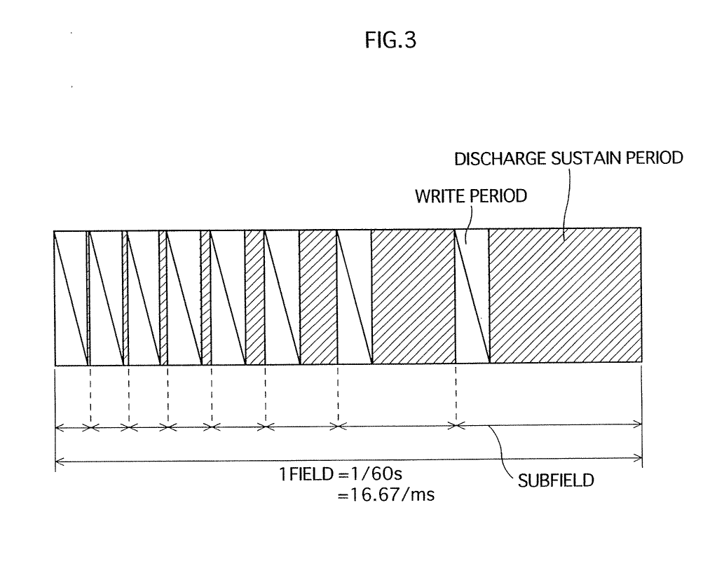

FIG. 3 is a diagram illustrating a frame division method when driving a plasma display device. A left to right direction in the drawing shows the time flow, and shaded areas indicate a sustain period.

For example, in an example of the division method illustrated in FIG. 3, one frame is made of 8 subfields, and a proportion of the sustain periods in the subfields in each frame is set 1:2:4:8:16:32:64:128. An image of 256 grayscale is displayed by this combination of 8 bit binary. NTSC television images are made of 60 frames per minute, and therefore time length of one frame is 16.7 ms.

Each subfield includes a sequence of an initialization period, a write period, the sustain period, and an erase period.

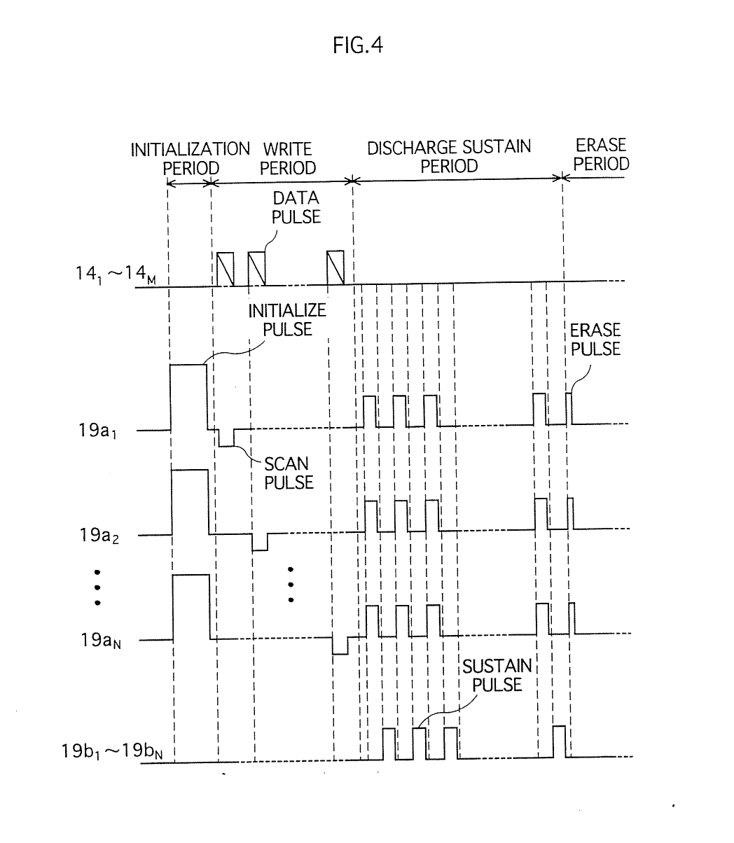

FIG. 4 is a timing chart when pulses are applied to display electrodes and data electrodes in one subfield.

In the initialization period, an initialize pulse is applied to all of the scanning electrodes 19a₁-19a_{N} at the same time in order to initialize charges in all of the discharge cells.

In the write period, a scan pulse is applied to the scanning electrodes 19a₁-19a_{N} in turn, and a data pulse is applied to selected electrodes among the data electrodes 14₁-14_{M} in order to accumulate wall charge in discharge cells to be emit light, and write in image information for one screen.

In the sustain period, a sustain pulse is applied to the scanning electrodes 19a₁-19a_{N} and the sustain electrodes 19b₁-19b_{N} at the same time, with alternating a polarity of the sustain pulse, and the discharge is caused in the discharge cells in which the wall charge is accumulated so as to emit light for a predetermined length of time.

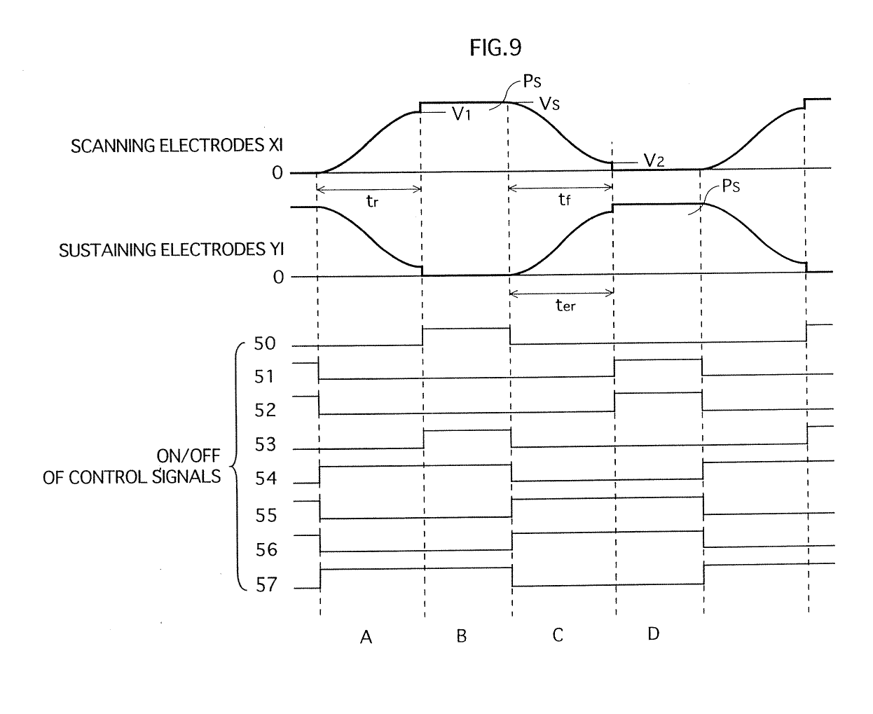

Although the sustain pulse in FIG. 4 is illustrated as a simple rectangular pulse for convenience, a waveform of the sustain pulse of the present invention in detail is, as illustrated in FIG. 9, such that having a gradual rising period and a gradual falling period. Forming of the waveform will be explained later.

In the erase period, a narrow erase pulse is applied to the scanning electrodes 19a₁-19a_{N} at the same time so that the wall charge in the discharge cells is erased.

1-2 Basic Method for Driving of Plasma Display Device

FIG. 5 is a block diagram illustrating a structure of a PDP driving unit 100.

The PDP driving unit 100 comprises a preprocessor 101 that processes image data inputted from an external image outputting device, a frame memory 102 that stores the processed image data, a sync pulse generating unit 103 that generates a sync pulse for each frame and each subfield, a scan driver 104 that applies a pulse to the scanning electrodes 19a₁-19a_{N}, a sustain driver 105 that applies a pulse to the sustaining electrodes 19b₁-19b_{N}, and a data driver 106 that applies a pulse to the data electrodes 14₁-14_{M}.

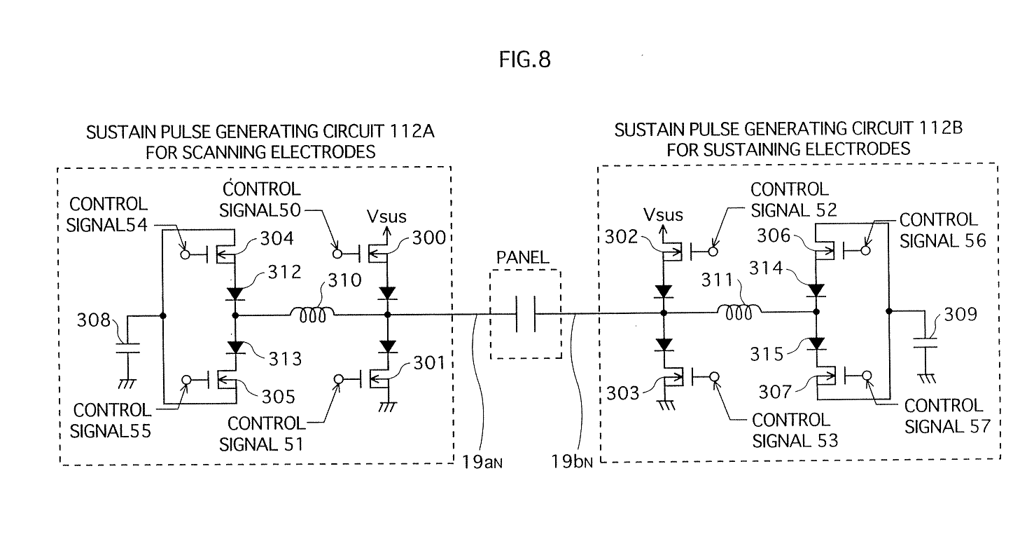

The preprocessor 101 extracts frame image data (image data for each frame) from the inputted image data, and generates subfield image data (image data for each subfield) out of the extracted frame image data, and then stores the generated subfield image data in the frame memory 102. Further, the preprocessor 101 outputs data of current subfield data that has been stored in the frame memory 102 to the data driver 106 line by line. The preprocessor 101 also detects a sync signal from inputted image data, such as a horizontal sync signal and a vertical sync signal, and transmits the sync signal to the sync pulse generating unit 103 in each frame and each subfield. Moreover, the preprocessor 101 transmits control signals 50-57 (FIG. 9) to switching elements 300-307 (FIG. 8) of sustain pulse generating circuits 112a and 112b, and controls on and off of the switching elements so as to form a predetermined waveform for the sustain pulse.

The frame memory 102 stores the subfield image data by frame.

Specifically, the frame memory 102 is a 2 port frame memory having two memory areas each for one frame (one memory area stores eight subfield image data, in an example illustrated in FIG. 3), and capable of writing frame image data in one of the memory areas while reading frame image data that is written in the other of the memory areas at the same time, alternately.

The sync pulse generating unit 103 refers to the sync signal transmitted from the preprocessor 101 for each frame and each subfield, and generates a trigger signal that instructs when the initialization pulse, the scan pulse, the sustain pulse, or the erase pulse start, and then transmits the trigger signal to each of the drivers 104-106.

The scan driver 104, in response to the trigger signal transmitted from the sync pulse generating unit 103, generates one of the initialization pulse, the scan pulse, the sustain pulse, and the erase pulse, and applies the generated pulse to at least one of the scanning electrodes 19a₁-19a_{N}.

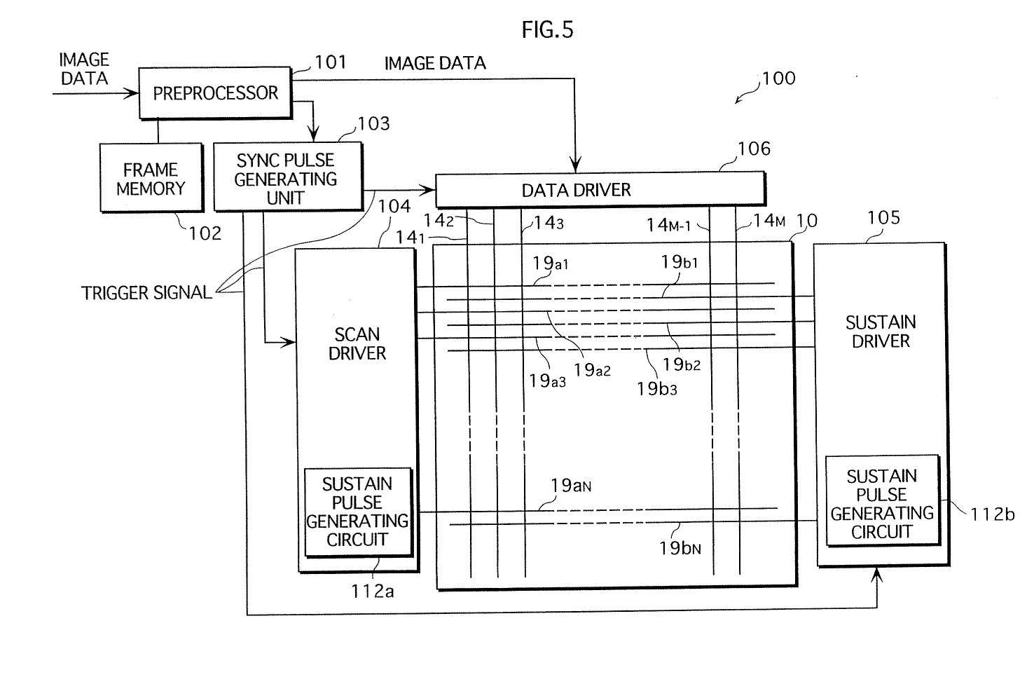

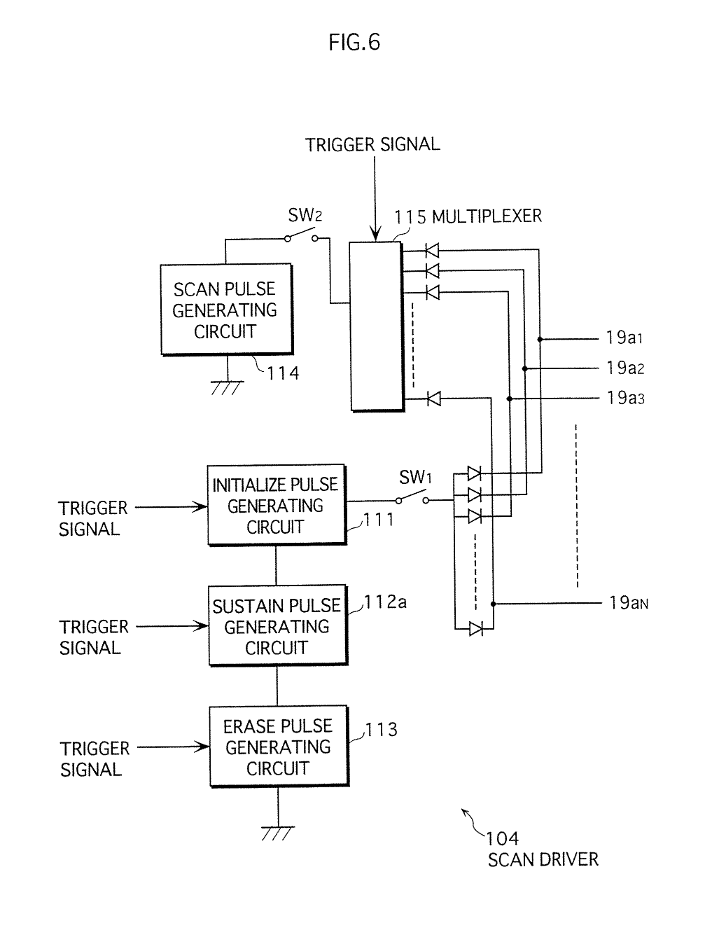

FIG. 6 is a block diagram illustrating a structure of the scanning driver 104.

The initialization pulse, the sustain pulse, and the erase pulse are applied to all of the scanning electrodes 19a₁-19a_{N}.

Therefore, as shown in FIG. 6, the scan driver 104 is provided with three pulse generating circuits (an initialization pulse generating circuit 111, a sustain pulse generating circuit 112a, and an erase pulse generating circuit 113). The three generating circuits are connected serially in a floating-ground configuration, and each applies the initialization pulse, the sustain pulse, and the erase pulse, respectively, to the scanning electrodes 19a₁-19a_{N} by performing an operation in response to the trigger signal transmitted from the sync pulse generating unit 103.

Further, in order to apply the scan pulse to the scanning electrodes 19a₁, 19a₂, . . . , and 19a_{N} in order, the scan driver 104 of the present invention is provided with a scan pulse generating unit 114 and a multiplexer 115 connected the scan pulse generating unit 114, as shown in FIG. 6, and generates the scan pulse at the scan pulse generating unit 114 and outputs the scan pulse after switching with the multiplexer 115 in response to the trigger signal transmitted from the sync pulse generating unit 103. However, the scan pulse generating unit may be provided to each scanning electrode 19a.

Further, switches SW1 and SW2 are provided in order to apply alternatively either the outputted pulse from one of the three pulse generating units 111-113, or the outputted pulse from the scan pulse generating circuit 114 to the scanning electrodes 19a₁-19a_{N}.

The sustain driver 105 (FIG. 5) is provided with a sustain pulse generating circuit 112b and, in response to the trigger signal transmitted from the sync pulse generating unit 103, generates the sustain pulse and applies the sustain pulse to the sustaining electrodes 19b₁-19b_{N}.

Note that the sustain pulse generating circuits 112a and 112b are LC resonant circuits as tank circuits provided with a coil 310 and a condenser 308, and a coil 311 and a condenser 309, respectively, and works as reactive power recovery circuits that recover reactive power out of power supplied between a pair of the scanning electrode 19a_{N} and the sustaining electrodes 19b_{N} so as to improve display efficiency.

The data driver 106 (FIG. 5) outputs the data pulse to the data electrodes 14₁-14_{M} in parallel based on subfield information that corresponds to a line that is serially inputted.

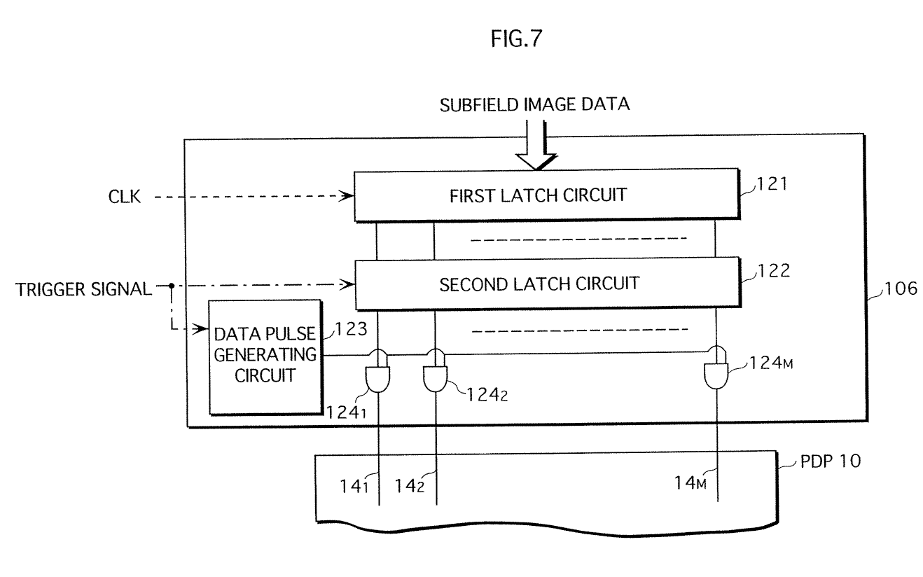

FIG. 7 is a block diagram illustrating a structure of the data driver 106.

The data driver 106 comprises a first latch circuit 121 that retrieves the subfield image data line by line, a second latch circuit 122 that stores the retrieved subfield image, the data pulse generating circuit 123 that generates the data pulse, and AND gates 124₁-124_{M} each provided to each of the data electrodes 14₁-14_{M}.

The first latch circuit 121, synchronizing with a CLK signal, retrieves the subfield image data, which is transmitted from the preprocessor 101 in order, by a few bits. Once the subfield image data (information that indicates whether the data pulse is applied for each of the data electrodes 14₁-14_{M}) for one scanning line is latched, the latched subfield image data is moved at once to the second latch circuit. The second latch circuit, in response to the trigger signal transmitted from the sync pulse generating unit 103, opens AND gates that correspond to data electrodes to which the data pulse is applied, from the AND gates 142₁-124_{M}. The data pulse generating circuit 123 generates the data pulse, synchronizing with the opening of the AND gates. By doing so, the data pulse is applied to the selected data electrodes that correspond to the opened AND gates, from the data electrodes 14₁-14_{M}.

The PDP driving unit 100 in an example shown in FIG. 3 displays an image of one frame by repeating an operation explained below for one subfield eight times. The subfield includes a sequence of the initialization period, the write period, the sustain period, and the erase period.

In the initialization period, the switch SW1 of the scan driver 104 is turned on, and the switch SW2 of the scan driver 104 is turned off. The initialize pulse generated by the initialize pulse generating circuit 111 is applied to all of the scanning electrodes 19a at the same time, and by this, an initializing discharge is performed in all of the discharge cells and the wall discharge is accumulated in each of the discharge cells. Here, by applying a degree of wall discharge to the discharge cells, it is possible to make a rising period of the write pulse in the following write period shorter.

In the write period, the switch SW1 is turned off, and the switch SW2 is turned on (FIG. 6). A negative scan pulse generated by the scan pulse generating circuit 114 is applied to the scanning electrodes 19a₁-19a_{N} line by line, from the first line to the last line in turn. At the same time, in order to perform the write discharge, a positive data pulse is applied to data electrodes in discharge cells to emit light selected from the data electrodes 14ₐ-14_{M}, and thus the wall charge is accumulated in the selected discharge cells. By accumulating the wall charge on a surface of the dielectric layer 17 of the selected discharge cells to emit light, information for an image of one screen is written.

A pulse width of the scan pulse and the data pulse (a write pulse width) is usually set around 1.25 μsec or larger.

In the sustain period, the switch SW1 in the scanning driver 104 is turned on, and the switch SW2 in the scanning driver 104 is turned off. An operation in which a sustain pulse having a predetermined width (e.g. 1-5 μsec) generated by the sustain pulse generating circuit 112a is applied to the scanning electrodes 19a₁-19a_{N} at the same time, and an operation in which another sustain pulse having the predetermined width generated by the sustain pulse generating circuit 112b is applied to the sustaining electrodes 19b₁-19b_{N} at the same time are repeated alternately.

By the above operations, in the discharge cells in which the wall discharge is accumulated during the write period, a sustain discharge starts when a potential on the surface of the dielectric layer 17 becomes larger than a discharge starting voltage. Then, the ultraviolet rays that are emitted due to the sustain discharge are converted to visible lights with the phosphor layers, and thus the visible lights each correspond to a color of the phosphor layer is emitted.

In the erase period, the switch SW1 of the scan driver 104 is turned on, and the switch SW2 of the scan driver 104 is turned off. The erase pulse having a narrow width generated by the erase pulse generating circuit 113 is applied to the scanning electrodes 19a₁-19a_{N} at the same time, and an incomplete discharge is performed so as to erase the wall charge in the discharge cells.

Main characteristics of the present invention are such as a waveform and an effect of the sustain pulse that is applied between the scanning electrodes 19a₁-19a_{N} and the sustain electrodes 19b₁-19b_{N} during the sustain period while driving the plasma display device. Detailed explanations about these characteristics are described in a first and second embodiments in the following.

### 2. First Embodiment

2-1 Detailed Structure of Sustain Pulse Generating Circuit

FIG. 8 is a diagram illustrating a structure of the sustain pulse generating circuits 112a and 112b, each included in the scan driver 104 and the sustain driver 105, respectively. As shown in the drawing, the sustain pulse generating circuits 112a and 112b are the tank circuits (the LC resonant circuits), and reactive circuits are formed by serially connecting the coils 310 and 311 to the condensers 308 and 309, respectively, thus work as reactive power recovery circuits during the rising period and the falling period of the sustain pulse applied to any pair of the display electrodes 19a_{N} and 19b_{N}. in the sustain period.

In the sustain pulse generating circuits 112a and 112b, an area of a panel above and between each pair of the display electrodes 19a_{N} and 19b_{N} is equivalent to a condenser. Each of the display electrodes 19a_{N} and 19b_{N} is connected to the coils 310 and 311, and the condensers 308 and 309 respectively, and power (voltage level Vsus) is supplied from an external power source. The sustain pulse generating circuits 112a and 112b are provided with the switching elements 300-307, and the control signals 50-57 are transmitted from the preprocessor which is a main controlling unit of the PDP driving unit. During a period in which the control signals 50-57 are outputted at a high level, corresponding switching elements 300-307 are turned on, and the external power Vsus or the power from the condenser 308 and 309 are supplied to the scanning electrodes 19a_{N} and the sustain electrodes 19b_{N}. The diodes 312-315 rectify currents that flow the sustain pulse generating circuits 112a and 112b. Adopting such sustain pulse generating circuits 112a and 112b enables to reduce the power loss due to the reactive power by recovering the reactive power in the condensers 308 and 309 during the falling period of the sustain pulse and applying the recovered reactive power to the display electrodes 19a_{N} and 19b_{N} in the rising period of the succeeding sustain pulse.

2-2 Operation in Sustain Pulse Generating Circuit

The characteristics of the first embodiment, as shown in the timing chart of the sustain pulse applied to the display electrodes in FIG. 9, is that, in waveforms of the pulses applied to the display electrodes 19a_{N} and 19b_{N}, the rising period and the falling period in one of the waveforms completely overlap with the falling period and the rising period of another of the waveforms, respectively. Accordingly, with the plasma display device of the first embodiment, it is possible to perform a high-speed drive at a desirable power consumption without a notable increase of the power loss due to the reactive power.

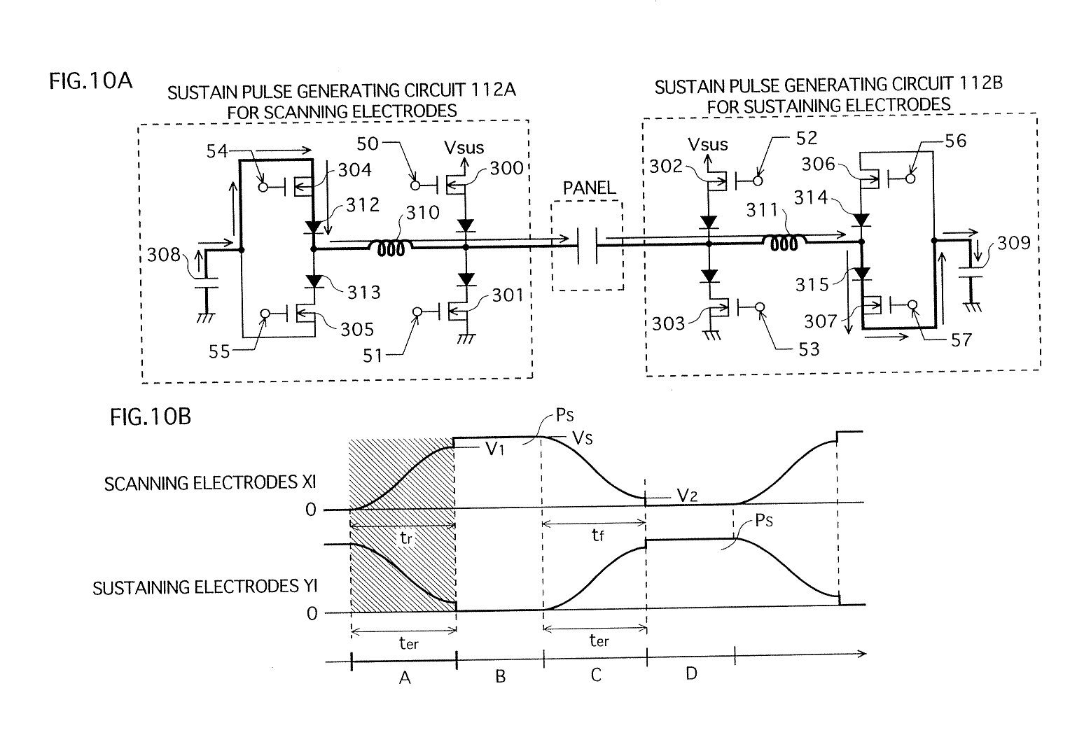

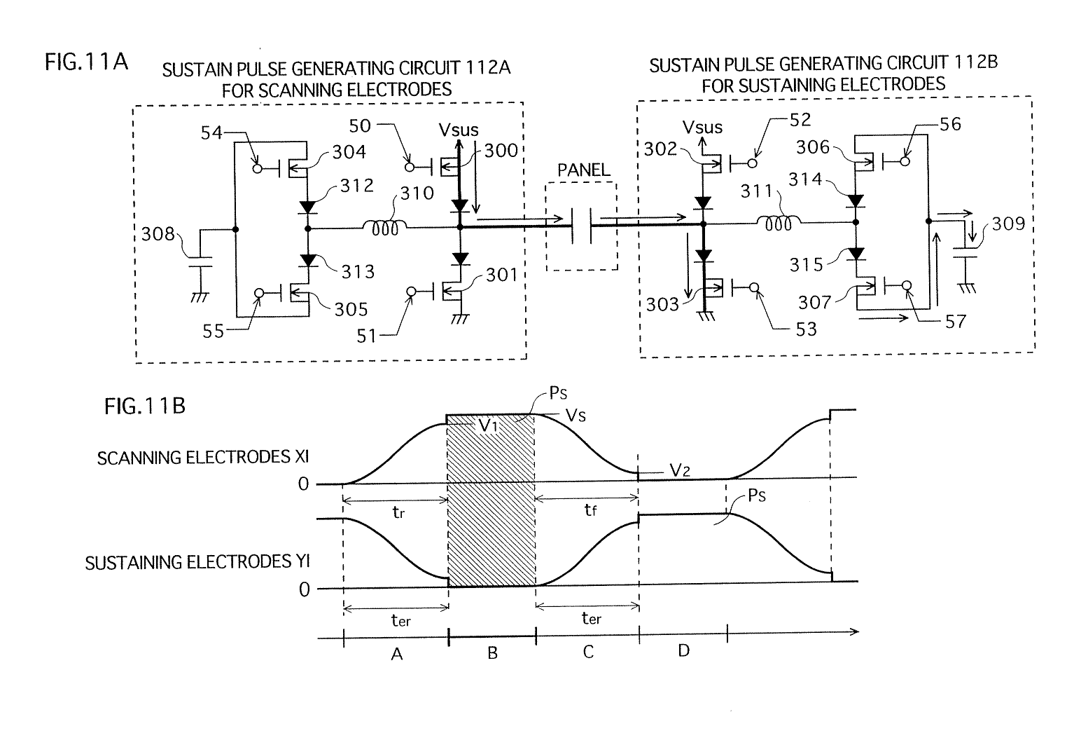

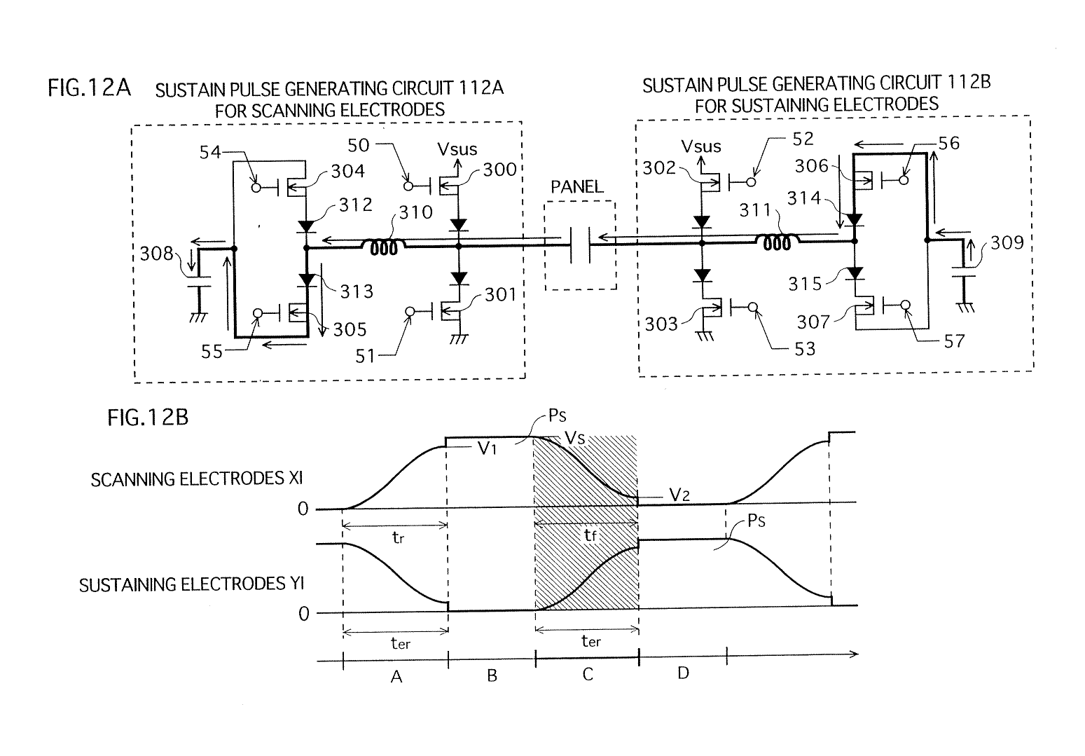

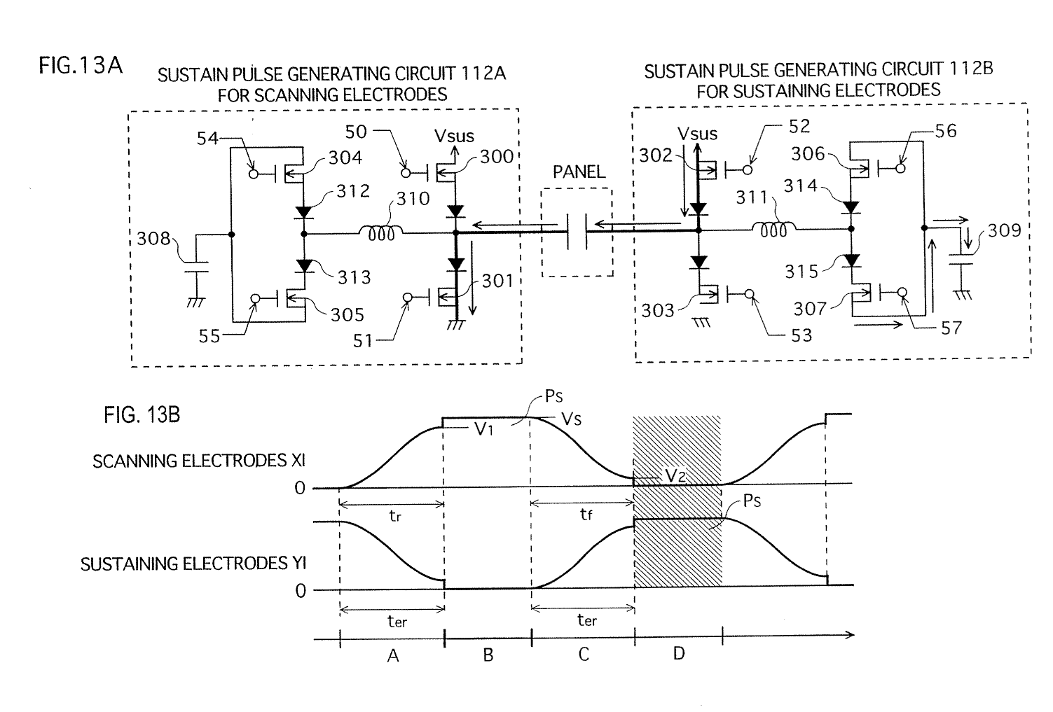

An operation for the reactive power recovery by the sustain pulse generating circuits 112a and 112b of the first embodiment is explained in reference to FIGS. 10-13. The explanation of the operation is given for each sub-period in the sustain period, dividing the sustain period into 4 sub-periods: a sub-period A (the rising period of the pulse to the scanning electrodes, and the falling period of the pulse to the sustaining electrodes), a sub-period B (applying a voltage Vs to the scanning electrodes, and grounding the sustaining electrodes), a sub-period C (the falling period of the pulse to the scanning electrodes, and the rising period of the pulse to the sustaining electrodes), and a sub-period D (grounding the scanning electrodes, and applying a voltage Vs to the sustaining electrodes).

*Sub-Period A (the rising period of the pulse to the scanning electrodes, and the falling period of the pulse to the sustaining electrodes)

The waveforms of the pair of the display electrodes 19a_{N} and 19b_{N} are as shown by an shaded area in FIG. 10B. The main characteristics of the first embodiment is that, in the waveforms of the display electrodes 19a_{N} and 19b_{N}, the rising period tᵣ of either of the display electrodes and the falling period t_{f} of another of the display electrodes completely overlap each other. A relation among tᵣ, t_{f}, and a total time tₑᵣ from the rising period of either of the display electrodes begins till the falling period of another of the display electrodes ends is expressed as tᵣ=t_{f}=tₑᵣ.

In the sub-period A illustrated in FIG. 10B, the scanning electrodes 19a_{N} are at a ground potential and the sustaining electrodes 19b_{N} are at the sustain voltage Vs. At the beginning of the sub-period A, the switching elements 301, 302, 305, and 306 in the sustain pulse generating circuits 112a and 112b are turned on, and the reactive power from a preceding sustain pulse is recovered in the condenser 308.

Then, the switching elements 301, 302, 305, and 306 are turned off, and the control signals 54 and 57 are transmitted to the switching elements 304 and 307 so as to turn the two switching elements on. The condensers 308 and 309 in the sustain pulse generating circuits 112a and 112b, respectively, are electrically connected to each other with the coils 310 and 311 with the panel in-between. By doing so, as shown in FIG. 10A, the reactive power recovered in the condenser 308 is charged to the panel by an LC resonant effect so as to raise the potential of the scanning electrodes from the ground potential to V₁. At the same time, in the sustain pulse generating circuits 112b, the electricity charged to the panel is recovered in the condenser 309 by an LC resonant effect of the sustain pulse generating circuits 112b so that the potential of the sustaining electrodes 19b_{N} is reduced from Vₛ to V₂.

[Reason and Effect for Overlapping Rising Period and Falling Period of Sustain Pulses Applied to a Pair of Display Electrodes 19aN and 19bN]

In recent years, a demand for a plasma display device having a capability of a higher-definition display has been growing, and a number of scanning lines in the plasma display device is also increasing in order to meet this demand. With such a trend, a popular plasma display device adopting an intra-field time division grayscale display method is also pressed for a reduction of driving time.

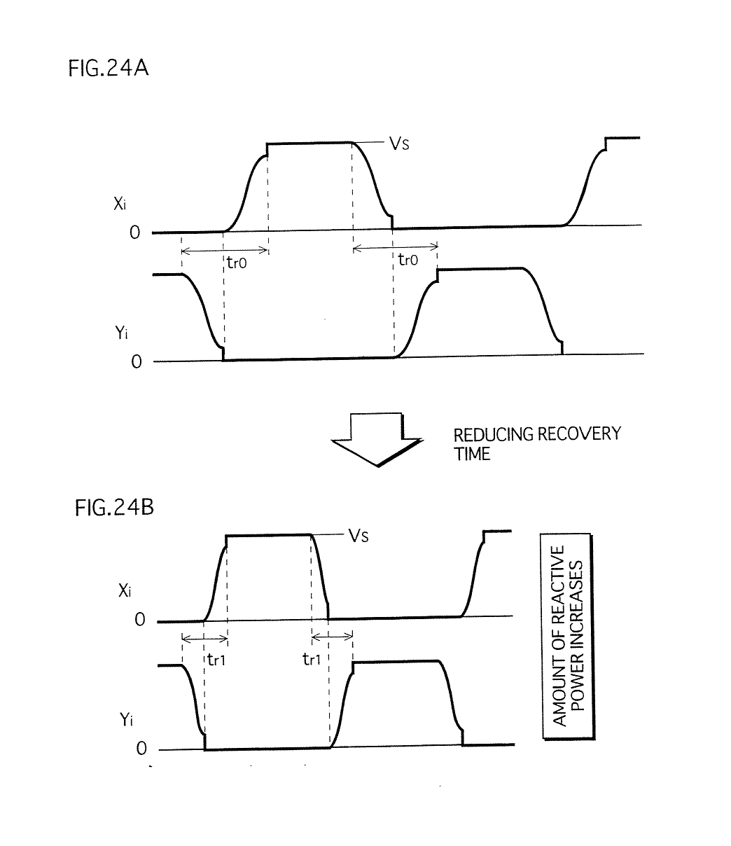

In view of the above circumstance, it is also desired that a length of the sustain period becomes shorter in order to meet the demand for a high-speed drive. However, in a case of a plasma display device provided with the reactive power recovery circuits, making tᵣ and t_{f} short in order to reduce the length of the sustain period increases the power loss due to the reactive power as shown by the equation 4. FIG. 24A illustrates waveforms of the sustain pulses applied to the scanning electrodes 19a_{N} and the sustain electrodes 19b_{N} of the conventional plasma display panel. If a pulse width of the conventional plasma display panel is made shorter by reducing a total time period t_{f0} from the rising period of one of the pair of display electrodes till the falling period of another of the pair of the display electrode (the waveform shown in FIG. 24A) down to a total time period t_{f1} (the waveform shown in FIG. 24B), this would result in a considerable increase of the reactive power.

The driving waveform process of the present invention as a result of a dedicated research by inventors of the present invention is such that the rising period of either of the pair of the display electrodes overlaps the falling period of another of the pair of the display electrodes. By such a waveform, an interval between the sustain pulses applied to the pair of the display electrodes becomes shorter even without making tᵣ and t_{f} short (i.e. without making the ramp part steep). Therefore, with the first embodiment, even when the PDP is a high-definition hi-vision display with a high-speed driving method, it does not necessary to make the sustain pulse as short as the sustain pulse of the conventional PDP, and accordingly it is possible to effectively suppress an increase of the power loss due to the reactive power, and obtain an excellent display performance.

Note that, in the sub-period A, a small amount of power loss is caused due to a circuit included in the plasma display device, and therefore the voltages of the scanning electrodes 19aN and the sustaining electrodes 19bN at the end of this period are not a complete opposite of voltages at the beginning of this period. A difference in the potential is supplied in the succeeding sub-period B.

*Sub-Period B (applying a voltage Vs to the scanning electrodes, and grounding the sustaining electrodes)

By turning the switching elements 300 and 303 on at the same time, the voltage V₁ of the scanning electrodes is raised to the sustain voltage Vₛ. Also at the same time, the voltage V₂ of the sustaining electrodes is reduced to the grounding voltage.

*Sub-Period C (the falling period of the pulse to the scanning electrodes, and the rising period of the pulse to the sustaining electrodes)

Next, by turning the switching elements 300, 303, 304, and 307 off at the same time and turning the switching elements 305 and 306 on at the same time, the condenser 308 of the sustain pulse generating circuit 112a and the condenser 309 of the sustain pulse generating circuit 112b are electrically connected to the coil 310 and the coil 311, respectively, with the panel in-between. By doing so, as shown in FIG. 12A, the reactive power in the panel is recovered in the condenser 308 by an LC resonant effect and the potential of the scanning electrodes 19a_{N} is reduced from Vₛ to V₂. At the same time, in the sustain pulse generating circuits 112b, the electricity recovered in the condenser 309 is charged to the panel by an LC resonant effect and the potential of the sustaining electrodes 19b_{N} is raised from the grounding voltage to V₁. Changes of the voltages of the display electrodes 19a_{N} and 19b_{N} in the sub-period C are a complete reversal of changes in the sub-period A.

*Sub-Period D (grounding the scanning electrodes, and applying a voltage Vs to the sustaining electrodes)

Next, by turning the switching elements 301 and 302 on at the same time, the voltage of the scanning electrodes is reduced from V₂ to the grounding voltage. Also at the same time, the voltage of the sustaining electrodes is raised from V₁ to the sustain voltage Vₛ. Changes of the voltages of the display electrodes 19a_{N} and 19b_{N} in the sub-period D are a complete reversal of changes in the sub-period B.

As has been described above, in the first embodiment, the recovery of the reactive power is performed by repeating the sequence of operation from the sub-period A through the sub-period D.

In the first embodiment, as is clear from the operations from the sub-period A through the sub-period D, the reactive power is recovered from one of the pair of the display electrodes 19a_{N} and 19b_{N} while the reactive power recovered previously is supplied to another of the pair of the display electrodes 19a_{N} and 19b_{N}. Accordingly, it is possible to drive at a higher speed in comparison with the plasma display device with a conventional driving waveform process, and to achieve a reduced power consumption at the same time.

2-3 Experimentation for Measuring Performance

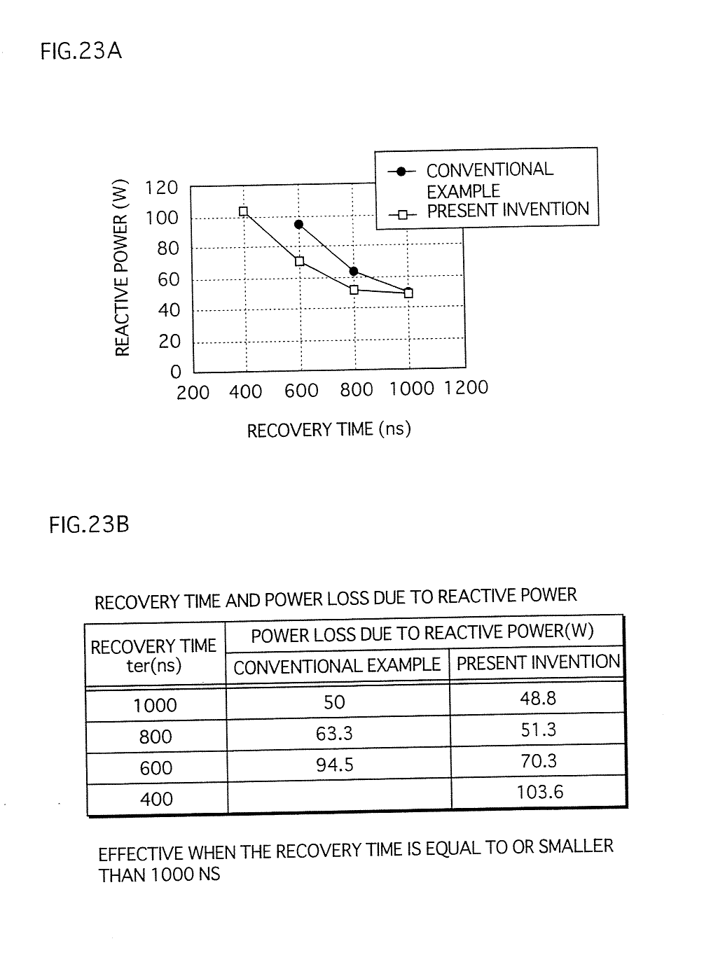

For the plasma display device of the present invention, a relation among the power loss due to the reactive power, the rising period tᵣ, and the falling period t_{f} is measured. Results are shown in a graph in FIG. 23A and a table in FIG. 23B.

As is clear from the drawings, it is possible to suppress the power loss due to the reactive power effectively for the most part of the recovery period by using the plasma display device of the present invention, in comparison with the conventional plasma display device. Especially, when the rising period tᵣ and the falling period t_{f} are between 600 ns and 1000 ns inclusive, the power loss due to the reactive power is notably reduced in comparison with the conventional plasma display device.

Accordingly, from the data in the drawings, it is clear that the present invention also has an effect that the power loss due to the reactive power does not increase even when the rising period tᵣ and the falling period t_{f} become slightly shorter. In other words, it may be possible to achieve a plasma display device that drives at dramatically a higher speed in comparison with the conventional plasma display device, and that has substantially the same mount of the power loss due to the reactive power as the conventional plasma display device. However, in deciding the rising period tᵣ and the falling period t_{f}, it is desirable to measure values of the power loss due to the reactive power for each case and compare results.

### 3. Second Embodiment

A structure of a plasma display device of a second embodiment is the same as the plasma display device of the first embodiment.

In the example of the first embodiment, the waveforms of the display electrodes 19a_{N} and 19b_{N} are such that the rising period tᵣ of either of the display electrodes and the falling period t_{f} of another of the display electrodes completely overlap each other, and the relation among tᵣ, t_{f}, and a total time tₑᵣ between the beginning of the rising period of either of the display electrodes and the ending of the falling period of another of the display electrodes is expressed as tᵣ=t_{f}=tₑᵣ. However, the present invention is not restricted to such an example, and it is possible to obtain the effect of the present invention to a certain extent, when the wave forms of the display electrodes are such that the rising period of either of the display electrodes and the falling period of another of the display electrodes partly overlap.

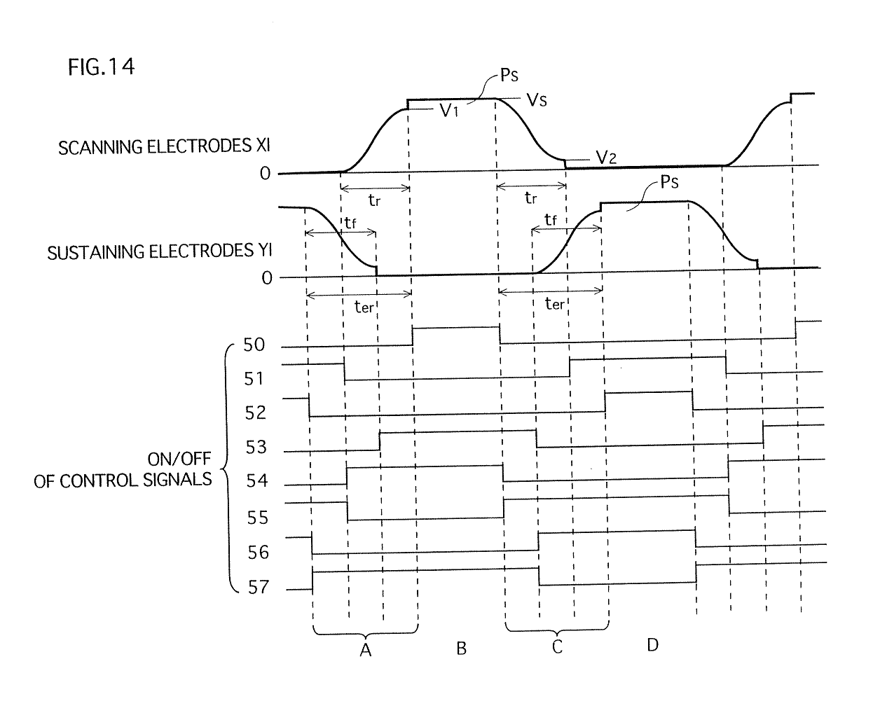

The second embodiment explains an example of such waveforms, as shown by a timing chart of FIG. 14 illustrating the sustain pulses to the display electrodes, that the rising period of either of the display electrodes and the falling period of another of the display electrodes overlap only ⅓ of the total time period between the beginning of the falling period and the ending of the rising period, namely a case in which an equation tₑᵣ=(tᵣ+t_{f})−t_{f}/3 is satisfied.

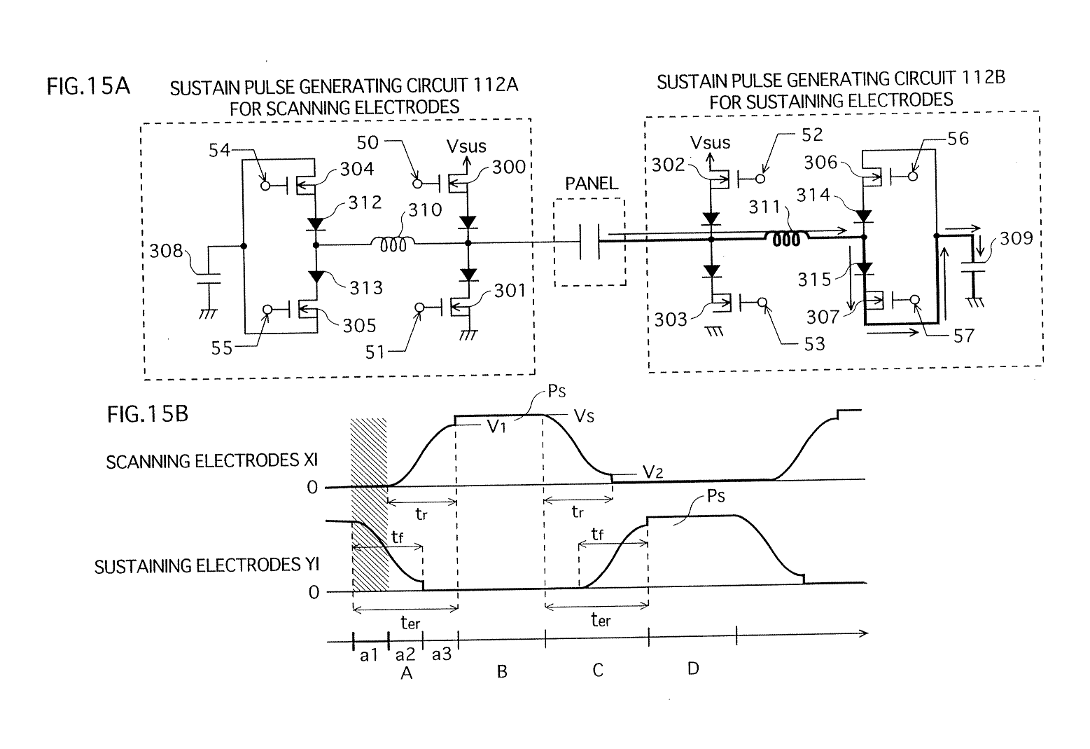

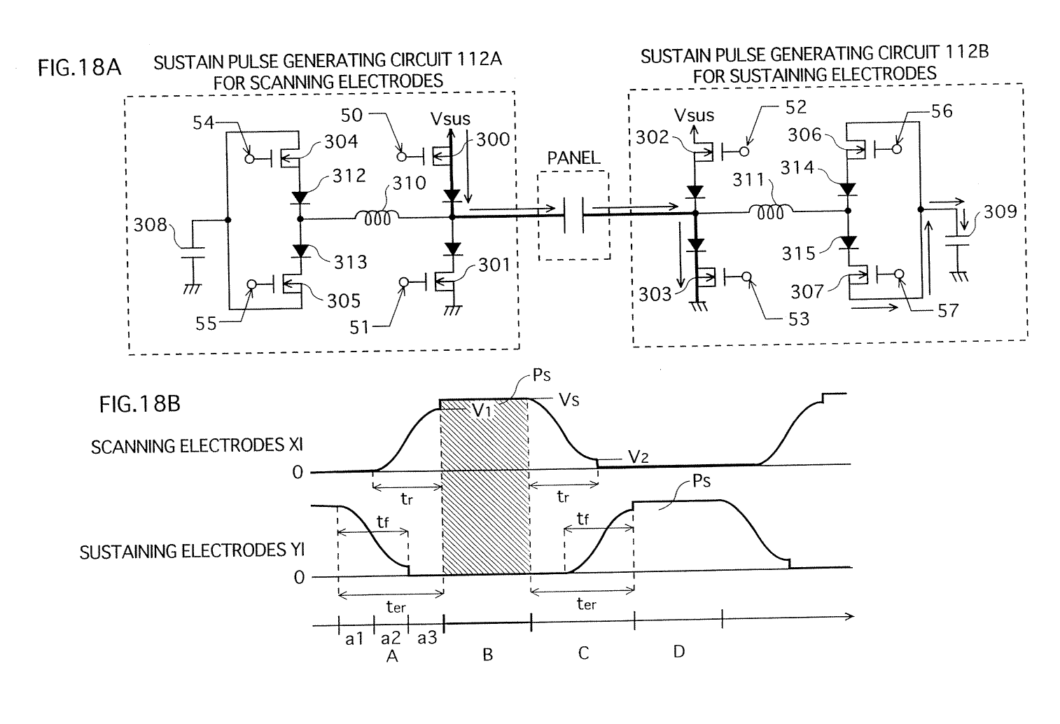

The example is explained in reference to FIGS. 15-18. In the explanation, the sustain period is divided in to 4 sub-periods, A, B, C, and D. The sub-period A and C, in which the starting and falling periods are included, are further divided into shorter periods, a1-a3 and c1-c3, respectively. Arrows in FIGS. 15A-18A illustrate a flow of current. FIG. 14 illustrates on/off (high/low) of the control signals 50-57 corresponding to the switching elements 300-307, respectively.

3-1. Operation in Sustain Pulse Generating Circuit

*Sub-Period A-a1 (grounding the scanning electrodes, and the falling period of the pulse to the sustaining electrodes)

As shown in FIG. 15B, at the beginning of the sub-period A-a1, the scanning electrodes 19a_{N} are at a ground potential and the sustaining electrodes 19b_{N} are at the sustain voltage Vₛ (only the switching elements 301, 302, 305, and 306 are turned on). Then the switching elements 301, 302, 305, and 306 are turned off at the same time. Next, by turning the switching element 307 on, the reactive power in the panel is recovered and stored in the condenser 309 in the sustain pulse generating circuits 112b for the sustaining electrodes 19b_{N}, as shown in FIG. 15A.

*Sub-Period A-a2 (the rising Period of the pulse to the scanning electrodes, and the falling period of the pulse to the sustaining electrodes)

In the sub-period A-a2, when the switching element 304 is turned on at a point when ⅓ of the power recovery time tₑᵣ has passed since the beginning of the sub-period A, the condensers 308 and 309 are electrically connected to the coils 310 and 311, respectively, with the panel in-between. By doing so, the reactive power recovered in the condenser 308 is charged to the panel, as shown in FIG. 16A. At the same time, in the sustain pulse generating circuits 112b, the electricity charged to the panel is recovered in the condenser 309 and the potential of the sustaining electrodes 19b_{N} is reduced to V₂.

*Sub-Period A-a3 (the rising period of the pulse to the scanning electrodes, and grounding the sustaining electrodes)

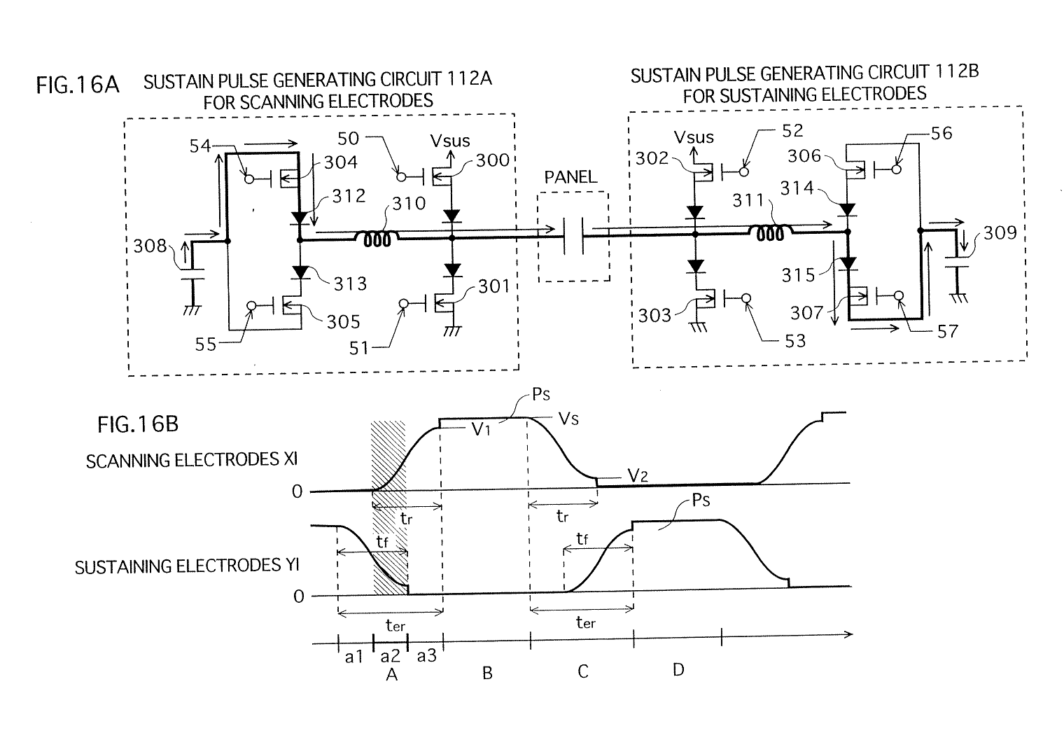

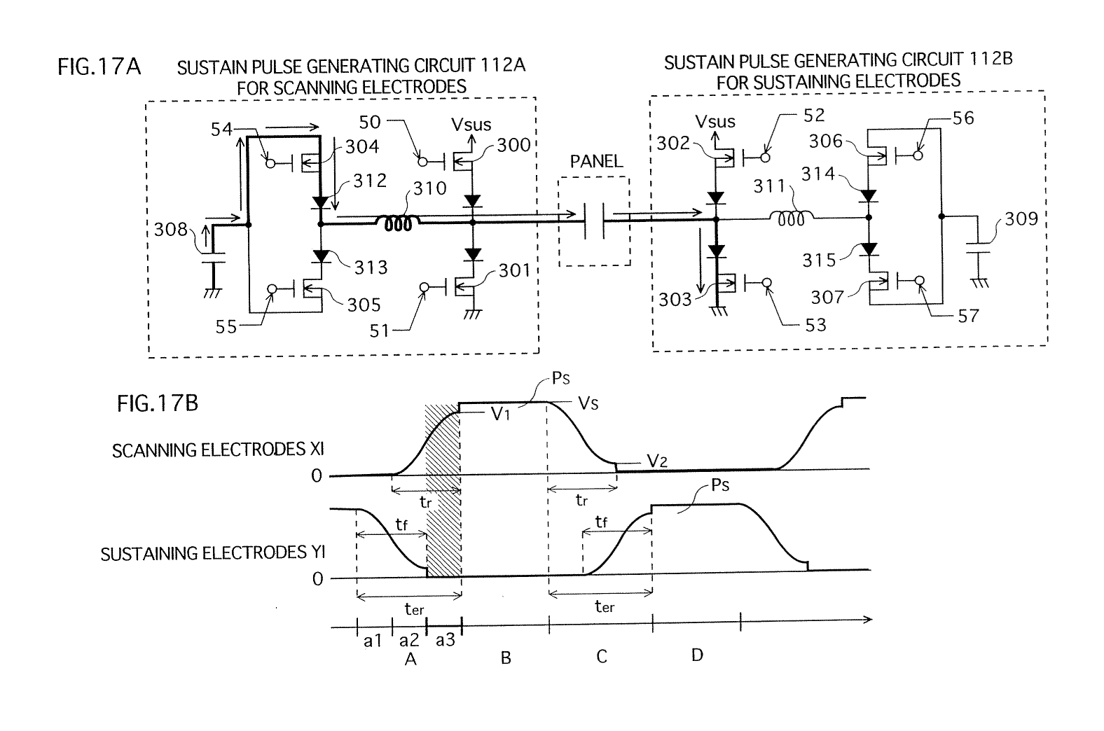

In the sub-period A-a3, as shown in FIG. 17A, by turning the switching elements 303 on at a point when ⅔ of the power recovery time tₑᵣ has passed since the beginning of the sub-period A, the reactive power recovered in the condenser 308 is kept charged to the panel, and the voltage of the scanning electrodes 19a_{N} is raised to the sustain voltage V₁. Also at the same time, the voltage V₂ of the sustaining electrodes 19b_{N} is reduced to the grounding voltage.

*Sub-Period B (applying the sustain voltage Vs to the scanning electrodes, and grounding the sustaining electrodes)

In the sub-period B, as shown in FIG. 8A, by turning the switching elements 300 on, the voltage V₁ of the scanning electrodes 19a_{N} is raised to the sustain voltage Vₛ. The voltage of the sustaining electrodes remains at the grounding voltage.

*Sub-Period C-c1 (the falling period of the pulse to the scanning electrodes, and grounding the sustaining electrodes)

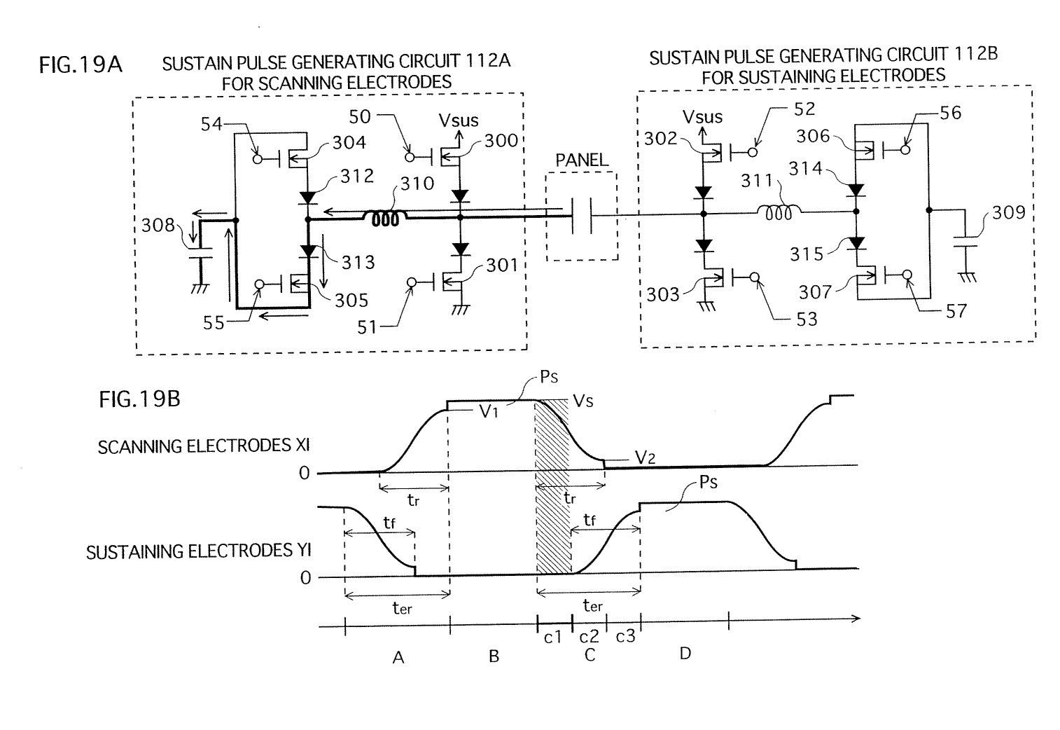

As shown in FIG. 19B, at the beginning of the sub-period C-c1, the scanning electrodes 19a_{N} are at the sustain voltage Vₛ and the sustaining electrodes 19b_{N} are at a ground potential. Then, the switching elements 300, 303, 304, and 307 are turned off at the same time. Next, by turning the switching element 305 on, the reactive power in the panel is recovered in the sustain pulse generating circuits 112a for the sustaining electrodes 19a_{N}, and stored in the condenser 308, as shown in FIG. 19A.

*Sub-Period C-c2 (the falling period of the pulse to the scanning electrodes, and the rising period of the pulse to the sustaining electrodes)

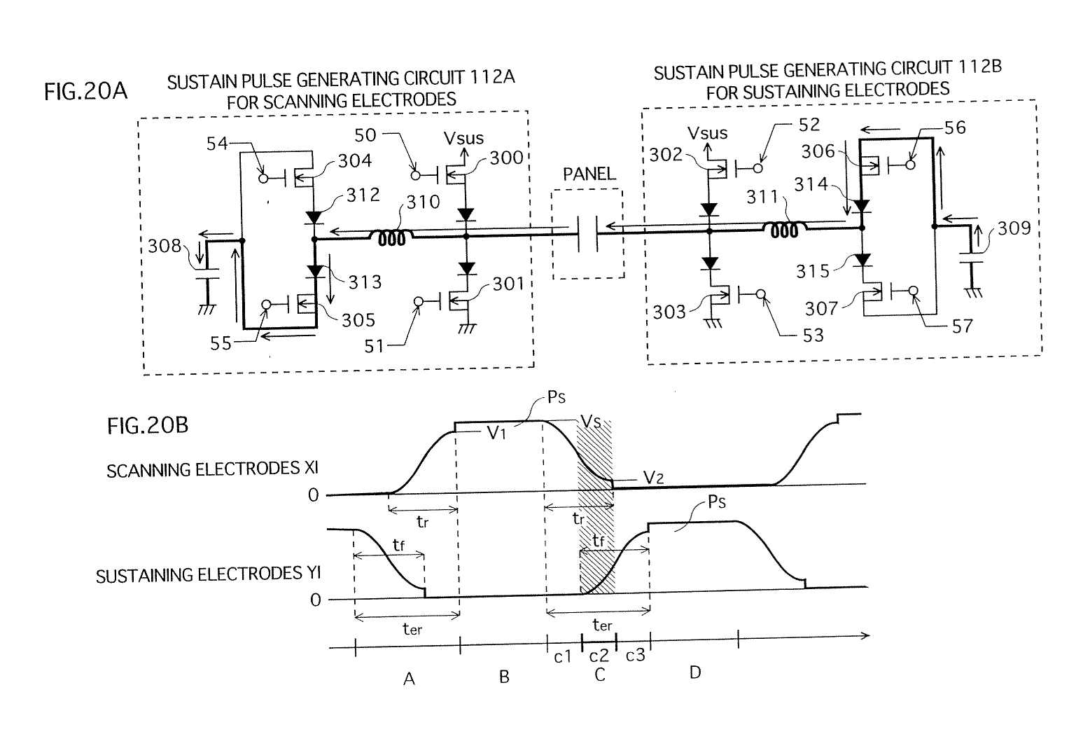

In the sub-period C-c2, when the switching elements 305 and 306 are turned on at a point when ⅓ of the power recovery time tₑᵣ has passed since the beginning of the sub-period C, the condensers 308 and 309 are electrically connected to the coils 310 and 311, respectively, with the panel in-between. By doing so, as shown in FIG. 20A, the reactive power recovered in the condenser 309 of the circuit 112b is charged to the panel. At the same time, in the sustain pulse generating circuits 112a, the electricity recovered in the condenser 309 is charged to the panel and the potential of the scanning electrodes 19b_{N} is reduced from Vₛ to V₂.

*Sub-Period C-c3 (grounding the scanning electrodes, and the rising period of the pulse to the sustaining electrodes).

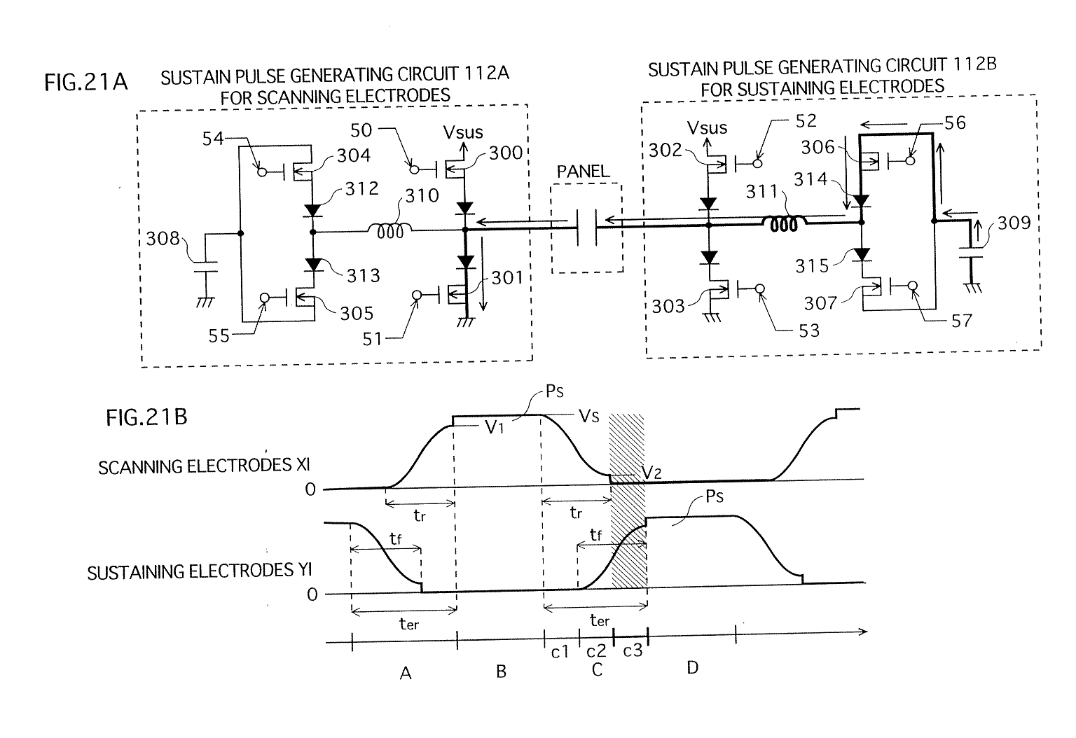

In the sub-period C-c3, as shown in FIG. 21A, by turning on the switching elements 306 at a point when ⅔ of the power recovery time tₑᵣ has passed since the beginning of the sub-period C, the reactive power recovered in the condenser 309 is kept charged to the panel, and the voltage of the sustaining electrodes 19b_{N} is raised to the sustain voltage V₁. Also at the same time, the voltage of the scanning electrodes 19b_{N} is reduced from V₂ to the grounding voltage.

*Sub-Period D (grounding the scanning electrodes, and applying a voltage Vs to the sustaining electrodes)

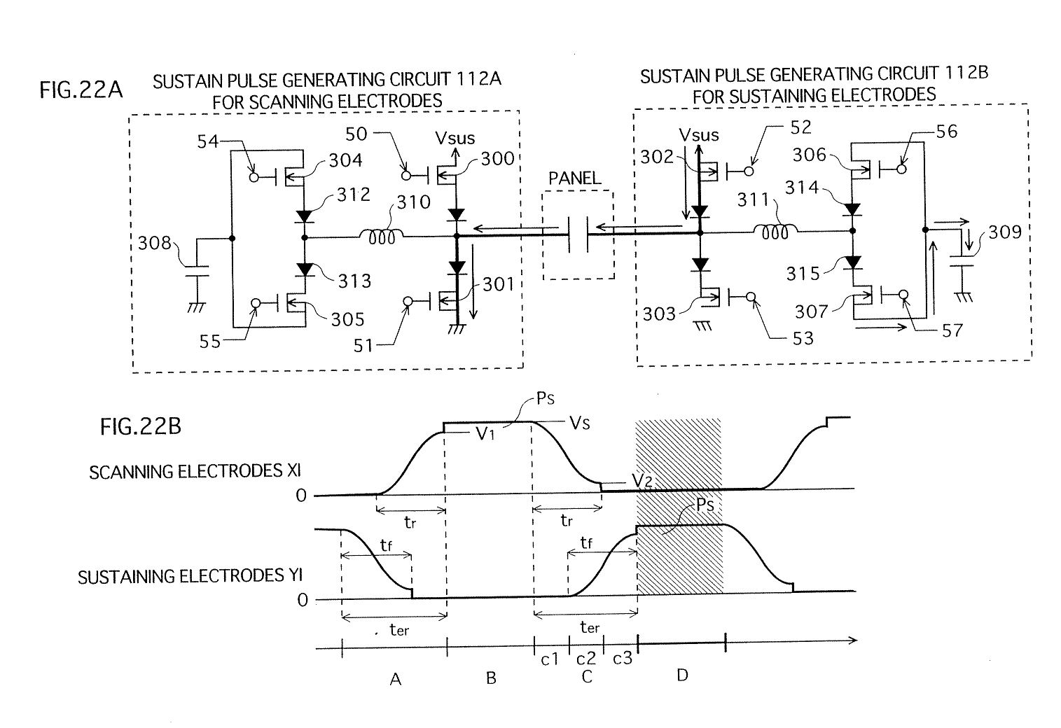

In the sub-period D, as shown in FIG. 22A, by turning the switching elements 301 on, the voltage of the sustaining electrodes 19b_{N} is raised from V₁ to the sustain voltage Vₛ. The voltage of the scanning electrodes is kept at the grounding voltage.

As has been explained above, the second embodiment enables, even when the waveforms of the display electrodes are such that the rising period tᵣ of either of the display electrodes and the falling period t_{f} of another of the display electrodes only partly overlap, to make the rising period tᵣ and the falling period t_{f} shorter by the overlapping period, and therefore it is possible to achieve a high definition plasma display device driving at a high speed with a small amount of power consumption, suppressing an increase of the reactive power.

### 4. Other Matters

The sustain pulse generating circuits 112a and 112b may be provided to each electrode of the scanning electrodes 19a₁-19a_{N} and the sustaining electrodes 19b₁-19b_{N}, respectively. It is also possible that the scanning electrodes 19a₁-19a_{N} and the sustaining electrodes 19b₁-19b_{N} are each divided into small groups and each group is provided with the sustain pulse generating circuits 112a and 112b, respectively.

### INDUSTRIAL APPLICABILITY

The present invention may be applied to the plasma display devices for an information terminal device, a display for a personal computer, and a display for a television set.

1. A method of driving a plasma display device, the plasma display device including (i) a PDP unit that includes a first and a second substrate arranged so as to face each other, the first substrate having pairs of scan and sustain electrodes disposed on a surface that faces the second substrate and a dielectric layer covering the pairs of the scan and sustain electrodes, and (ii) a PDP driving unit that drives the PDP unit based on an intra-field time division grayscale display method, and includes a plurality of LC resonant circuits for recovering reactive power from power supplied to the scan and sustain electrodes while driving, the scan and sustain electrodes being connected to different LC resonant circuits, the method comprising:
a recovering step of recovering the reactive power using the LC resonant circuits during a falling period of a sustain pulse; and
a supplying step of supplying the recovered reactive power to the scan and sustain electrodes during a rising period of the sustain pulse, wherein
the PDP driving unit repeats the recovering step and the supplying step cyclically, and
in each cycle, the falling period of the sustain pulse applied to the sustain electrode and the rising period of the sustain pulse applied to the scan electrode overlap only partially.

2. A plasma display device comprising:
a PDP unit that includes a first and a second substrate arranged so as to face each other, the first substrate having a plurality of display electrode pairs each made up of a scan electrode and a sustain electrode disposed on a surface that faces the second substrate and a dielectric layer covering the pairs of the scan and sustain electrodes; and
a PDP driving unit that drives the PDP unit based on an intra-field time division grayscale display method, and includes a plurality of LC resonant circuits for recovering reactive power from power supplied to the scan and sustain electrodes while driving, the scan and sustain electrodes being connected to different LC resonant circuits, wherein
the PDP driving unit repeats a cycle of recovering the reactive power using the LC resonant circuits during a falling period of a sustain pulse, and supplying the recovered reactive power to the scan or sustain electrode during a rising period of the sustain pulse, and
in each cycle, the falling period of the sustain pulse applied to the sustain electrode and the rising period of the sustain pulse applied to the scan electrodes overlap only partially.

3. A plasma display device according to claim 2, wherein the LC resonant circuits are each connected to a different display electrode.

4. A plasma display driving device that drives a PDP unit based on an intra-field time division grayscale display method to display an image, and recovers reactive power from power supplied to the PDP unit to improve display efficiency, the PDP unit including a first and a second substrate arranged so as to face each other, the first substrate having pairs of scan and sustain electrodes disposed on a surface that faces the second substrate, the plasma display driving device comprising:
a first reactive power recovery circuit that recovers reactive power from power supplied to the sustain electrodes; and
a second reactive power recovery circuit that recovers reactive power from power supplied to the scan electrodes, wherein
the first and second reactive power recovery circuits are electrically connected in series via the pairs of scan and sustain electrodes during a period in each subfield,
the reactive power recovered by one of the reactive power recovery circuits is transferred to the other reactive power recovery circuit via the pairs of scan and sustain electrodes,
the first and second reactive power recovery circuits are electrically independent, and
the period in each subfield is a period in which a rising period of the sustain pulse applied to the sustain electrode and a falling period of the sustain pulse applied to the scan electrode overlap only partially.

5. A plasma display driving device according to claim 4, wherein
the first and second reactive power recovery circuits are each provided with a voltage application circuit and a ground circuit that are in parallel,
during a period of a sustain discharge, the following operations are sequentially performed:
the first and second reactive power recovery circuits are disconnected from the display electrodes, and then
the voltage application circuit provided for one of the first and second reactive power recovery circuits is connected to the other one of scan or sustain electrode in the pair.

6. A plasma display driving device according to claim 4, wherein
the reactive power recovery circuits are reactance circuits.

7. A plasma display driving device according to claim 6, wherein
the reactance circuits are LC resonant circuits.

8. A plasma display driving device according to claim 4, further comprising:
a first switching unit operable to connect and disconnect the sustain electrode to and from the first reactive power recovery circuit;
a second switching unit operable to connect and disconnect the scan electrode to and from the second reactive power recovery circuit; and
a controlling unit operable to turn on the first and second switching units at the same time during the period in each subfield.

9. A plasma display device comprising:
a PDP unit that includes a first and a second substrate arranged so as to face each other, the first substrate having pairs of scan and sustain electrodes disposed on a surface that faces the second substrate and a dielectric layer covering the pairs of the scan and sustain electrodes; and
a PDP driving unit that drives the PDP unit based on an intra-field time division grayscale display method, and includes a first reactive power recovery circuit that recovers reactive power from power supplied to the scan electrodes, and a second reactive power recovery circuit that recovers the reactive power from power supplied to the sustain electrodes, wherein
the first and second reactive power recovery circuits are electrically connected in series via the pairs of scan and sustain electrodes during a period in each subfield,
the reactive power recovered by one of the reactive power recovery circuits is transferred to the other reactive power recovery circuit via the pairs of scan and sustain electrodes,
the first and second reactive power recovery circuits are electrically independent, and
the period in each subfield is a period in which a rising period of the sustain pulse applied to the sustain electrodes and a filling period of the sustain pulse applied to the scan electrodes overlap only partially.

10. A plasma display device according to claim 9, wherein
the reactive power recovery circuits are reactance circuits.

11. A plasma display device according to claim 10, wherein
the reactance circuits are LC resonant circuits.

12. A plasma display device according to claim 9, further comprising:
a first switching unit operable to connect and disconnect the sustain electrode to and from the first reactive power recovery circuit;
a second switching unit operable to connect and disconnect the scan electrode to and from the second reactive power recovery circuit; and
a controlling unit operable to turn on the first and second switching units at the same time during the period in each subfield.

13. A plasma display device according to claim 9, wherein
the first and second reactive power recovery circuits are each provided with a voltage application circuit and a ground circuit that are in parallel,
during a period of a sustain discharge, the following operations are sequentially performed:
the first and second reactive power recovery circuits are disconnected from the display electrodes, and then
the voltage application circuit provided for one of the first and second reactive power recovery circuits is connected to one of the scan or sustain electrode in each pair, and the ground circuit provided for the other reactive power recovery circuit is connected to the other one of scan or sustain electrodes in the pair.

14. The plasma display device of claim 2 wherein the plasma display driving device includes;
a first field effect transistor;
a first diode connected in series with the first field effect transistor;
a second diode connected in series with the first diode; and
a second field effect transistor connected in series with the second diode.

15. The plasma display device of claim 4 wherein the plasma display driving device includes;
a first field effect transistor;
a first diode connected in series with the first field effect transistor;
a second diode connected in series with the first diode; and
a second field effect transistor connected in series with the second diode.

16. The plasma display device of claim 9 wherein the plasma display driving device includes;
a first field effect transistor;
a first diode connected in series with the first field effect transistor;
a second diode connected in series with the first diode; and
a second field effect transistor connected in series with the second diode.

17. The plasma display device of claim 13 wherein the LC recover circuit or the reactive power recovery circuit includes an inductor connected in series with a condenser.
